(19) United States
(12) Patent Application Publication
(10) Pub. No.: US 2026/0133670 A1
(43) Pub. Date: May 14, 2026

(54) ELECTRONIC DEVICE AND OPERATION METHOD THEREOF

(71) Applicant: Samsung Electronics Co., Ltd., Suwon-si (KR)

(72) Inventors: Kihan SHIN, Suwon-si (KR); Goun LEE, Suwon-si (KR); Wonchang LEE, Suwon-si (KR)

(21) Appl. No.: 19/440,945

(22) Filed: Jan. 6, 2026

Related U.S. Application Data
(63) Continuation of application No. PCT/KR2024/008020, filed on Jun. 12, 2024.

(30) Foreign Application Priority Data
Jul. 31, 2023 (KR) 10-2023-0099427
Aug. 25, 2023 (KR) 10-2023-0111908

(51) Int. Cl. G06F 3/04817; G06F 3/0488; G06F 3/14

(52) U.S. Cl. CPC G06F 3/04817; G06F 3/0488; G06F 3/14

(57) ABSTRACT

An electronic device is provided. The electronic device includes a first housing including a first surface and a second surface facing the direction opposite to the direction which the first surface faces, a second housing including a third surface and a fourth surface facing the direction opposite to the direction which the third surface faces, a hinge which is disposed between the first housing and the second housing and which changes a folding state of the electronic device, a foldable display disposed on the first surface and the third surface, a plurality of ports disposed on a side surface of the first housing or a side surface of the second housing, and a processor, the processor identifies the folding state, identifies at least one event, and displays at least one icon corresponding to at least one port from among the plurality of ports in at least one area of the foldable display on the basis of the folding state and the at least one event, the at least one area corresponds to the location of the at least one port from among the plurality of ports.

### CROSS-REFERENCE TO RELATED APPLICATION(S)

This application is a continuation application, claiming priority under 35 U.S.C. § 365(c), of an International application No. PCT/KR 2024/008020, filed on Jun. 12, 2024, which is based on and claims the benefit of a Korean patent application number 10-2023-0099427, filed on Jul. 31, 2023, in the Korean Intellectual Property Office, and of a Korean patent application number 10-2023-0111908, filed on Aug. 25, 2023, in the Korean Intellectual Property Office, the disclosure of each of which is incorporated by reference herein in its entirety.

### BACKGROUND

### 1. Field

The disclosure relates to an electronic device and an operation method thereof.

### 2. Description of Related Art

Due to the diversification of peripheral devices of electronic devices (e.g., mobile phones, tablets, notebook computers, monitors), connectivity of electronic devices is an important issue. An electronic device may be connected to another electronic device through a port. A user may not recognize positions of ports disposed on an electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and an operation method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a first housing including a first surface and a second surface facing in a direction opposite to a direction in which the first surface faces, a second housing including a third surface and a fourth surface facing in a direction opposite to a direction in which the third surface faces, a hinge disposed between the first housing and the second housing and configured to change a folding state of the electronic device, a foldable display disposed on the first surface and the third surface, a plurality of ports disposed on a side surface of the first housing or a side surface of the second housing, memory, comprising one or more storage media, storing instructions, and one or more processors communicatively coupled to the foldable display, and the memory, wherein the instructions, when executed by the one or more processors individually or collectively, cause the electronic device to identify the folding state, identify at least one event, and display, based on the folding state and the at least one event, at least one icon corresponding to at least one port among the plurality of ports on at least one area of the foldable display, wherein the at least one area corresponding to a position of the at least one port among the plurality of ports.

In accordance with another aspect of the disclosure, a method performed by an electronic device is provided. The method includes identifying, by the electronic device, a folding state of the electronic device, identifying, by the electronic device, at least one event, and displaying, by the electronic device based on the folding state and the at least one event, at least one icon corresponding to at least one port among a plurality of ports disposed on a side surface of a housing of the electronic device on at least one area of a foldable display of the electronic device, the at least one area corresponds to a position of the at least one port among the plurality of ports.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying, by the electronic device, a folding state of the electronic device, identifying, by the electronic device, at least one event, and displaying, by the electronic device based on the folding state and the at least one event, at least one icon corresponding to at least one port among a plurality of ports disposed on a side surface of a housing of the electronic device on at least one area of a foldable display of the electronic device, wherein the at least one area corresponds to a position of the at least one port among the plurality of ports.

In accordance with another aspect of the disclosure, an electronic device is provided. The electronic device includes a housing, at least one port disposed on a side surface of the housing, a display disposed on a front surface of the housing, and a processor. The processor is configured to identify at least one event of a first event corresponding to a shortcut key input, a second event corresponding to a gesture input, a third event corresponding to tilt detection, a fourth event corresponding to touch detection of the side surface of the housing, or a fifth event corresponding to touch detection of a border of the display. The processor is configured to display, based on the at least one event, at least one icon corresponding to at least one of the at least one port on at least one area of the display corresponding to a position of the at least one port.

In accordance with another aspect of the disclosure, a method of operating an electronic device is provided. The method includes identifying at least one event of a first event corresponding to a shortcut key input, a second event corresponding to a gesture input, a third event corresponding to tilt detection, a fourth event corresponding to touch detection of a side surface of a housing of the electronic device, or a fifth event corresponding to touch detection of a border of a display of the electronic device. The method includes displaying, based on the at least one event, at least one icon corresponding to at least one of at least one port of the electronic device on at least one area of the display of the electronic device corresponding to a position of the at least one port of the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying at least one event of a first event corresponding to a shortcut key input, a second event corresponding to a gesture input, a third event corresponding to tilt detection, a fourth event corresponding to touch detection of a side surface of a housing of the electronic device, or a fifth event corresponding to touch detection of a border of a display of the electronic device. The operations include displaying, based on the at least one event, at least one icon corresponding to at least one of at least one port of the electronic device on at least one area of the display of the electronic device corresponding to a position of the at least one port of the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a view illustrating a front surface, a side surface, and a rear surface of an electronic device, according to an embodiment of the disclosure;

FIG. 3 is a view illustrating a folding state of an electronic device, according to an embodiment of the disclosure;

FIG. 4A is a view illustrating an unfolded state of an electronic device, according to an embodiment of the disclosure;

FIG. 4B is a view illustrating a folded state of an electronic device, according to an embodiment of the disclosure;

FIG. 5 is a flowchart illustrating an operation method of an electronic device, according to an embodiment of the disclosure;

FIG. 6 is a view illustrating an operation of an electronic device, according to an embodiment of the disclosure;

FIG. 7 is a flowchart illustrating an operation method of an electronic device, according to an embodiment of the disclosure;

FIG. 8 is a flowchart illustrating an operation method of an electronic device according to an embodiment of the disclosure;

FIG. 9 is a flowchart illustrating an operation method of an electronic device, according to an embodiment of the disclosure;

FIG. 10 is a flowchart illustrating an operation method of an electronic device, according to an embodiment of the disclosure;

FIG. 11 is a flowchart illustrating an operation method of an electronic device according to an embodiment of the disclosure;

FIG. 12 is a flowchart illustrating an operation method of an electronic device, according to an embodiment of the disclosure;

FIG. 13 is a view illustrating an operation of an electronic device, according to an embodiment of the disclosure;

FIG. 14 is a view illustrating operations of an electronic device according to an embodiment of the disclosure;

FIG. 15 is a view illustrating operations of an electronic device according to an embodiment of the disclosure;

FIG. 16 is a flowchart illustrating an operation method of an electronic device according to an embodiment of the disclosure;

FIG. 17 is a view illustrating an operation of an electronic device, according to an embodiment of the disclosure;

FIG. 18 is a view illustrating an operation of an electronic device, according to an embodiment of the disclosure;

FIG. 19 is a view illustrating operations of an electronic device according to an embodiment of the disclosure;

FIG. 20 is a flowchart illustrating an operation method of an electronic device according to an embodiment of the disclosure;

FIG. 21 is a flowchart illustrating an operation method of an electronic device according to an embodiment of the disclosure;

FIG. 22 is a flowchart illustrating an operation method of an electronic device, according to an embodiment of the disclosure;

FIG. 23 is a flowchart illustrating an operation method of an electronic device, according to an embodiment of the disclosure; and

FIG. 24 is a view illustrating an electronic device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

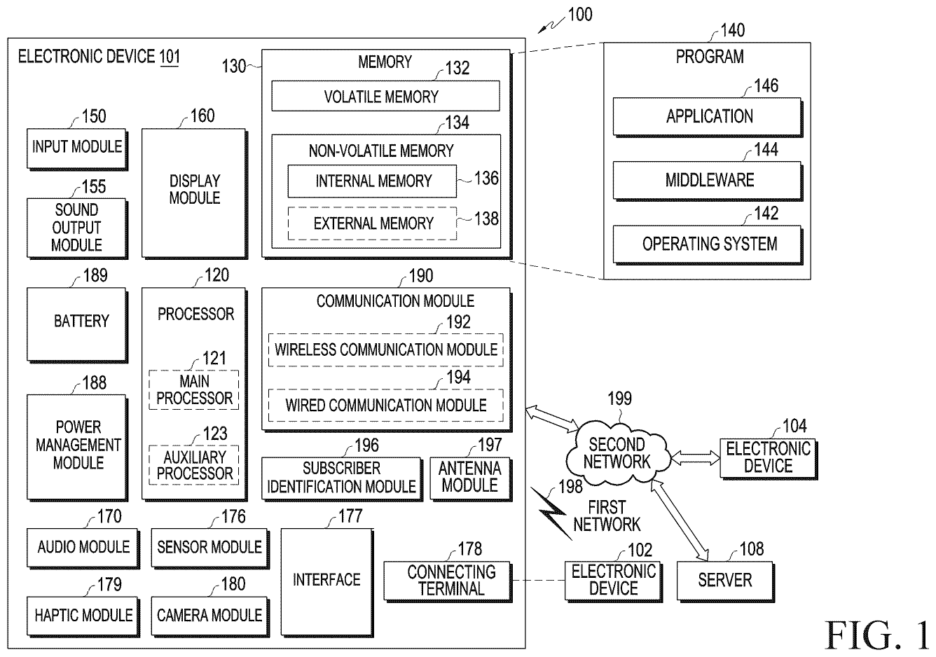

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beamforming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

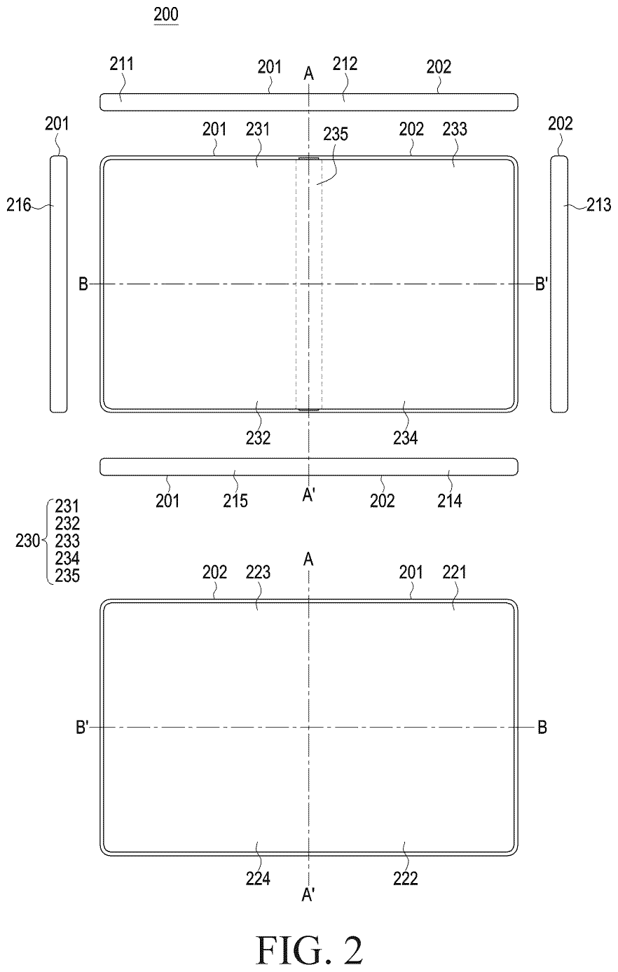

FIG. 2 is a view illustrating a front surface, a side surface, and a rear surface of an electronic device, according to an embodiment of the disclosure.

Referring to FIG. 2, the electronic device 200 of FIG. 2 may be the electronic device 101 of FIG. 1 or may be a device similar to the electronic device 101 of FIG. 1. The electronic device 200 of FIG. 2 may include components that are identical or similar to the components of the electronic device 101 of FIG. 1. An operation of the electronic device 200 of FIG. 2 may be understood as an operation of the electronic device 101 of FIG. 1 (e.g., a component of the electronic device 101 of FIG. 1). For example, the electronic device 200 may be a notebook computer, a tablet, a portable communication device (e.g., a smartphone), a computer device, a portable multimedia device, a portable medical device, a camera, a wearable device, or a home appliance device, but the disclosure is not limited thereto.

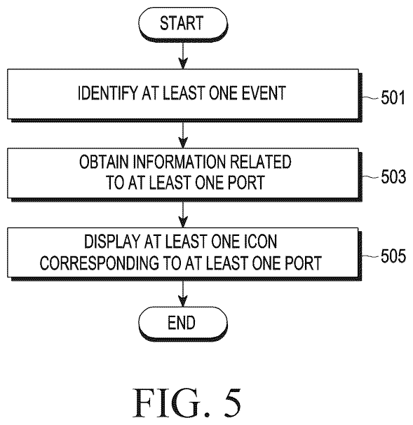

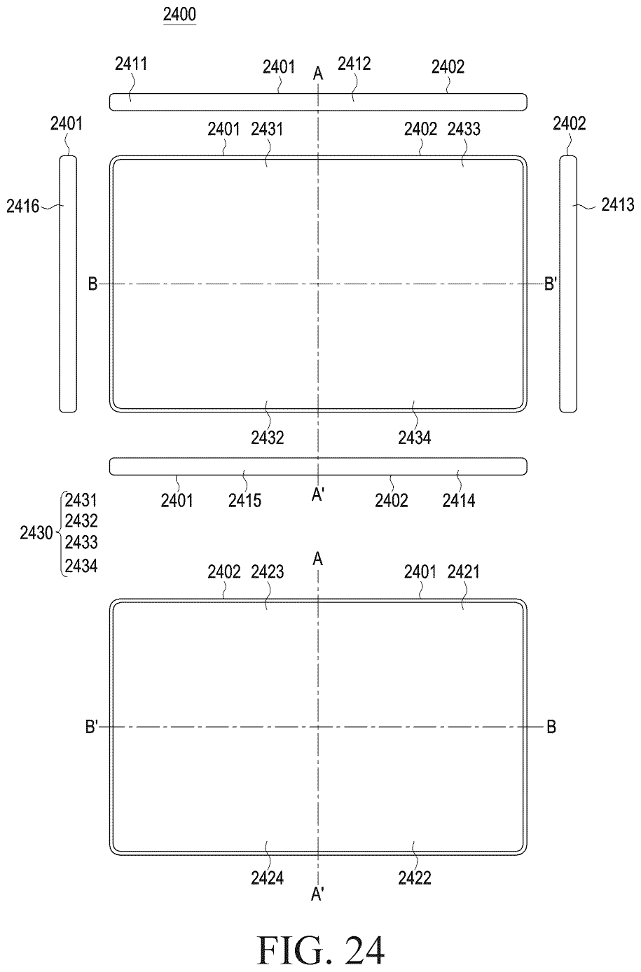

In an embodiment, the electronic device 200 of FIG. 2 may be a foldable device. The electronic device 2400 of FIG. 24 described below may be a non-folding device. The electronic device 2400 of FIG. 24 may differ from the electronic device 200 of FIG. 2 only in that it is not foldable. The embodiments related to folding of the electronic device 200 of FIG. 2 may not be applied to the electronic device 2400 of FIG. 24. The remaining embodiments except for the embodiments related to folding of the electronic device 200 of FIG. 2 may be applied to the electronic device 2400 of FIG. 24. Hereinafter, for convenience of description, embodiments for the electronic device 200 of FIG. 2 is described, and embodiments for the electronic device 2400 of FIG. 24 is omitted to the extent that they overlap the embodiments for the electronic device 200 of FIG. 2. For example, the embodiments of FIGS. 5, 6, 7, 8, 9, 10, 11, 12, 13, 14, 15, 20, 21, 22, and 23 may be described in relation to the electronic device 200 of FIG. 2, but may also be applied to the electronic device 2400 of FIG. 24.

In an embodiment, referring to FIG. 2, the electronic device 200 may include a foldable housing 201; 202 and a display module 160 (e.g., a foldable display 230) disposed in a space formed by the foldable housing 201; 202. In the embodiment of FIG. 2, at least a portion of the display module 160 may be flexible or foldable. For example, the display module 160 may include the foldable display 230. The foldable display 230 may include a plurality of areas 231; 232; 233; 234; 235. A surface on which the foldable display 230 is disposed (or a surface on which the foldable display 230 is visible from outside of the electronic device 200) may be defined as a front surface of the electronic device 200. A surface opposite to the front surface may be defined as a rear surface 221; 222; 223; 224 of the electronic device 200. A surface surrounding a space between the front surface and the rear surface 221; 222; 223; 224 may be defined as a side surface 211; 212; 213; 214; 215; 216 of the electronic device 200.

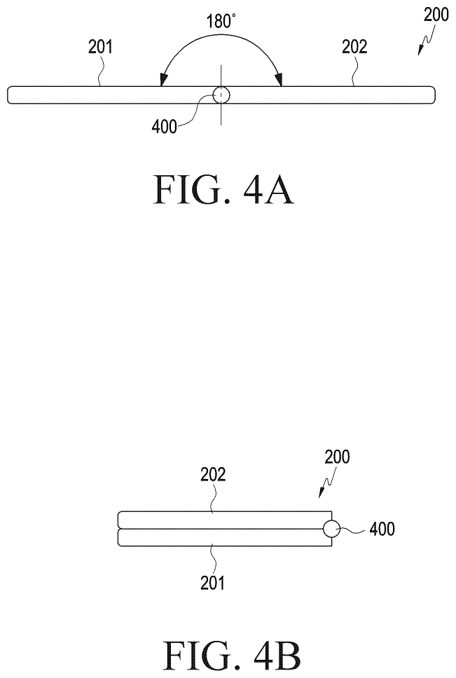

According to an embodiment, the foldable housing 201; 202 may include a first housing 201, a second housing 202, a first rear cover 221; 222, a second rear cover 223; 224, and a hinge (or hinge structure) (e.g., the hinge 400 of FIGS. 4A and 4B described below). The foldable housing 201; 202 of the electronic device 200 is not limited to the shape and combination illustrated in FIG. 2, and may be implemented by other shapes or combinations and/or assemblies of portions. For example, the first housing 201 and the first rear cover 221; 222 may be integrally formed, and the second housing 202 and the second rear cover 223; 224 may be integrally formed.

According to an embodiment, the first housing 201 may be connected to a hinge (e.g., the hinge 400 of FIGS. 4A and 4B described below). The first housing 201 may include a first surface facing in a first direction and a second surface facing in a second direction opposite to the first direction. The second housing 202 may be connected to a hinge (e.g., the hinge 400 of FIGS. 4A and 4B described below). The second housing 202 may include a third surface facing in a third direction and a fourth surface facing in a fourth direction opposite to the third direction.

According to an embodiment, the first housing 201 may rotate relative to the second housing 202 about a hinge (e.g., the hinge 400 of FIGS. 4A and 4B described below) (or a first axis A-A′ (e.g., a folding axis)). Thus, the electronic device 200 may switch the state between a folded state or unfolded state. For example, a state of the hinge (e.g., the hinge 400 of FIGS. 4A and 4B described below) of the electronic device 200 may be switched between a folded state and an unfolded state. For example, when the hinge (e.g., the hinge 400 of FIGS. 4A and 4B described below) of the electronic device 200 is in the folded state, the first direction in which the first surface of the first housing 201 faces may be substantially opposite to the third direction in which the third surface of the second housing 202 faces. When the hinge (e.g., the hinge 400 of FIGS. 4A and 4B described below) of the electronic device 200 is in the unfolded state, the first direction may be substantially the same as the third direction. The direction may mean a direction of the normal to the surface, but is not limited thereto.

According to an embodiment, the first housing 201 and the second housing 202 may be disposed on two opposite sides of the first axis A-A′ (e.g., the folding axis). As described below, an angle or distance between the first housing 201 and the second housing 202 may vary according to whether a state of the electronic device 200 is an unfolded state, a folded state, or a partially unfolded (or partially folded) intermediate state. For example, the unfolded state may be defined as 180 degrees, the folded state may be defined as 0 degrees, and the intermediate state may be defined as greater than 0 degrees and less than 180 degrees. For example, the unfolded state may be defined as 180 degrees to a first angle (e.g., 170 degrees), the folded state may be defined as 0 degrees to a second angle (e.g., 10 degrees), and the intermediate state may be defined as the second angle (e.g., 10 degrees) to the first angle (e.g., 170 degrees). The angle ranges of the unfolded state, the folded state, and the intermediate state are not limited thereto.

According to an embodiment, at least a portion of the first housing 201 and the second housing 202 may be formed of a metal material or a non-metal material having a stiffness of a selected size to support the foldable display 230. At least a portion formed of metal may provide a ground plane of the electronic device 200 and may be electrically connected with a ground line formed on the printed circuit board.

According to an embodiment, one or more components or sensors may be disposed or visually exposed on the rear surface 221; 222; 223; 224 of the electronic device 200. For example, a sensor exposed through the rear surface 221; 222; 223; 224 may include a proximity sensor or a rear camera.

According to an embodiment, the foldable display 230 may be disposed on a space formed by the foldable housing 201; 202. For example, the foldable display 230 may be seated on a recess formed by the foldable housing 201; 202 and may constitute most of the front surface of the electronic device 200. For example, the first housing 201 and the second housing 202 of the foldable housing 201; 202 may together form a recess receiving the foldable display 230.

According to an embodiment, the front surface of the electronic device 200 may include the foldable display 230 and a partial area of the first housing 201 adjacent to the foldable display 230 and a partial area of the second housing 202.

According to an embodiment, the rear surface 221; 222; 223; 224 of the electronic device 200 may include the first rear cover 221; 222, a partial area of the first housing 201 adjacent to the first rear cover 221; 222, the second rear cover 223; 224, and a partial area of the second housing 202 adjacent to the second rear cover 223; 224.

According to an embodiment, the foldable display 230 may refer to a display module in which at least a partial area may be deformed into a flat or curved surface. For example, the foldable display 230 may include a foldable area 235, an area disposed on one side (e.g., the left side of the foldable area 235 illustrated in FIG. 2) based on the foldable area 235 (e.g., a first area 231 on the upper side and a second area 232 on the lower side based on a second axis B-B′), and an area disposed on the other side (e.g., the right side of the foldable area 235 illustrated in FIG. 2) based on the foldable area 235 (e.g., a third area 233 on the upper side and a fourth area 234 on the lower side based on the second axis B-B′). For example, in FIG. 2, the foldable display 230 may include a foldable area 235 located in the center, a first area 231 located in the upper left, a second area 232 located in the lower left, a third area 233 located in the upper right, and a fourth area 234 located in the lower right. Left, right, upper, lower, upper left, lower left, upper right, and lower right are defined based on FIG. 2, and the positions of the plurality of areas 231; 232; 233; 234; 235 of the foldable display 230, such as left, right, upper, lower, upper left, lower left, upper right, and lower right, may be defined differently according to the rotation of the electronic device 200.

According to an embodiment, the foldable area 235 of the foldable display 230 may correspond to an area where the hinge (e.g., the hinge 400 of FIGS. 4A and 4B described below) is located. The foldable area 235 may be folded in response to the hinge (e.g., the hinge 400 of FIGS. 4A and 4B described below) being folded and may be unfolded in response to being unfolded.

Meanwhile, the area division of the foldable display 230 illustrated in FIG. 2 is exemplary, and the foldable display 230 may be divided into a plurality (e.g., 6 or more or 4 or less) of areas according to structure or function. Further, the plurality of areas 231; 232; 233; 234; 235 of the foldable display 230 are logically distinguished areas for convenience of description and may not be hardware-separated areas.

According to an embodiment, the side surface 211; 212; 213; 214; 215; 216 of the electronic device 200 may include a first side surface 211, a second side surface 212, a third side surface 213, a fourth side surface 214, a fifth side surface 215, and a sixth side surface 216. The first side surface 211, the fifth side surface 215, and the sixth side surface 216 may be side surfaces of the first housing 201. The second side surface 212, the third side surface 213, and the fourth side surface 214 may be side surfaces of the second housing 202. The first side surface 211 and the second side surface 212 may form one side surface. The first side surface 211 and the second side surface 212 may be distinguished based on the first axis A-A′ (e.g., the folding axis). The fourth side surface 214 and the fifth side surface 215 may form one side surface. The fourth side surface 214 and the fifth side surface 215 may be distinguished based on the first axis A-A′ (e.g., the folding axis). The third side surface 213 may be one undivided side surface. The sixth side surface 216 may be one undivided side surface.

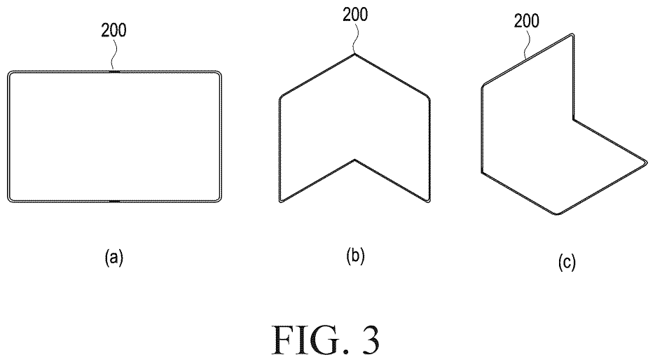

FIG. 3 is a view illustrating a folding state of an electronic device, according to an embodiment of the disclosure.

Referring to FIG. 3, part (a) of FIG. 3 illustrates the electronic device 200 in an unfolded state. Parts (b) and (c) of FIG. 3 show the electronic device 200 in a partially unfolded (or partially folded) intermediate state. Part (b) of FIG. 3 illustrates the electronic device 200 in the intermediate state disposed horizontally. Part (c) of FIG. 3 illustrates the electronic device 200 in the intermediate state disposed vertically. Horizontal or vertical may be defined differently, but according to an embodiment, a state in which a portion of the rear surface of the electronic device 200 is disposed substantially parallel to the ground surface may be defined as a state in which the electronic device 200 is mounted vertically. For example, a state in which the first axis A-A′ (e.g., the folding axis) of FIG. 2 is disposed substantially parallel to the ground surface may be defined as a vertical state of the electronic device 200 or a state in which the electronic device 200 is disposed vertically.

FIG. 4A is a view illustrating an unfolded state of an electronic device, according to an embodiment of the disclosure.

FIG. 4B is a view illustrating a folded state of an electronic device, according to an embodiment of the disclosure. FIGS. 4A and 4B are cross-sectional views schematically illustrating the electronic device 200 illustrated in FIG. 2 cut along a second axis B-B′.

Referring to FIGS. 4A and 4B, the electronic device 200 may identify the unfolded state or the folded state of the electronic device 200 by at least one sensor (e.g., the sensor module 176 of FIG. 1). For example, the at least one sensor (e.g., the sensor module 176 of FIG. 1) may include at least one of an angle sensor, a distance sensor, a gyro sensor, or a hall sensor. For example, the electronic device 200 may identify whether a state of the electronic device 200 is an unfolded state or a folded state using a tilt, acceleration, gravity of at least one housing of the electronic device 200 detected through the at least one sensor (e.g., the sensor module 176 of FIG. 1), and a distance between the first housing 201 and the second housing 202 of the foldable housing 201; 202 provided in the electronic device 200. For example, the electronic device 200 may identify whether a state of the electronic device 200 is an unfolded state or a folded state using an unfolded state or a folded state of a hinge structure (e.g., the hinge 400 or a hinge structure including the hinge 400) detected through the at least one sensor (e.g., the sensor module 176 of FIG. 1). For example, the electronic device 200 may identify an unfolded state or a folded state of the electronic device 200 using a rotation direction or rotation angle of at least one hinge structure (e.g., the hinge 400 or a hinge structure including the hinge 400) provided in the electronic device 200 detected through the at least one sensor (e.g., the sensor module 176 of FIG. 1).

FIG. 4A illustrates an unfolded state of a hinge structure (e.g., the hinge 400 or a hinge structure including the hinge 400). For convenience of description, a folding angle in a completely unfolded state of a hinge structure (e.g., the hinge 400 or a hinge structure including the hinge 400) may be defined as 180 degrees. However, this is for convenience of description, and a folding angle in a completely unfolded state of a hinge structure (e.g., the hinge 400 or a hinge structure including the hinge 400) may be defined as 0 degrees. According to an embodiment, in an unfolded state of a hinge structure (e.g., the hinge 400 or a hinge structure including the hinge 400), the foldable display (e.g., the foldable display 230 of FIG. 2) may form substantially one plane.

FIG. 4B illustrates a folded state of a hinge structure (e.g., the hinge 400 or a hinge structure including the hinge 400). For example, FIG. 4B illustrates a state in which the first surface of the first housing 201 and the third surface of the second housing 202 are disposed facing each other in a folded state of a hinge structure (e.g., the hinge 400 or a hinge structure including the hinge 400). According to an embodiment, in a folded state of a hinge structure (e.g., the hinge 400 or a hinge structure including the hinge 400), a partial area (e.g., 231, 232) of the foldable display (e.g., the foldable display 230 of FIG. 2) may be disposed facing another partial area (e.g., 233, 234).

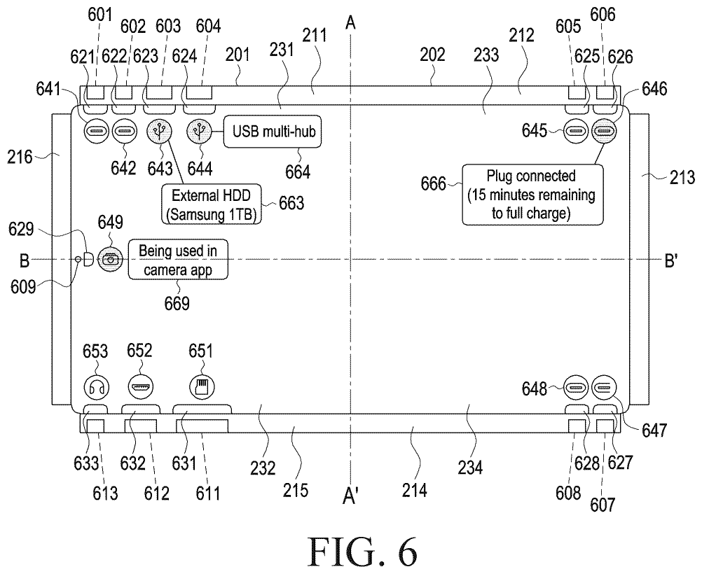

FIG. 5 is a flowchart illustrating an operation method of an electronic device, according to an embodiment of the disclosure. FIG. 5 may be described with reference to previously described embodiments and FIG. 6. FIG. 6 is a view illustrating an operation of an electronic device, according to an embodiment of the disclosure.

FIG. 6 may be a diagram describing a front surface (e.g., a surface on which the foldable display 230 is exposed) and side surfaces 211, 212, 213, 214, 215, 216 of the electronic device 200.

Referring to FIG. 6, a plurality of ports 601; 602; 603; 604; 605; 606; 607; 608; 611; 612; 613 disposed on the side surfaces 211, 212, 213, 214, 215, 216 of the electronic device 200 may be described. With reference to FIG. 6, icons 621; 622; 623; 624; 625; 626; 627; 628; 631; 632; 633; 641; 642; 643; 644; 645; 646; 647; 648; 651; 652; 653; 663; 664; 666 corresponding to the plurality of ports 601; 602; 603; 604; 605; 606; 607; 608; 611; 612; 613 disposed on the side surfaces 211, 212, 213, 214, 215, 216 of the electronic device 200 may be described.

Referring to FIGS. 5 and 6, the display of icons 621; 622; 623; 624; 625; 626; 627; 628; 631; 632; 633; 641; 642; 643; 644; 645; 646; 647; 648; 651; 652; 653; 663; 664; 666 corresponding to the plurality of ports 601; 602; 603; 604; 605; 606; 607; 608; 611; 612; 613 disposed on the side surfaces 211, 212, 213, 214, 215, 216 of the electronic device 200 may be described.

According to an embodiment, the electronic device 200 may include a processor (e.g., 120 of FIG. 1). The operations of the electronic device 200 may be controlled by the processor (e.g., 120 of FIG. 1) of the electronic device 200. The electronic device 200 performing a specific operation may mean that the electronic device 200 or a component included in the electronic device 200 is controlled by the processor (e.g., 120 of FIG. 1) of the electronic device 200. The electronic device 200 may include one or more processors (e.g., 120 of FIG. 1), and hereinafter, even when implemented with a plurality of processors, it is described as “an operation of the electronic device 200” or “an operation of the processor (e.g., 120 of FIG. 1)” for convenience of description. According to an embodiment, the processor (e.g., 120 of FIG. 1) of the electronic device 200 or software (e.g., program 140) executed by the processor (e.g., 120 of FIG. 1) may include various modules (e.g., hardware modules or software modules). The various modules may be implemented as hardware modules or software modules, and the various modules is described without distinguishing whether they are implemented as hardware modules or software modules. The modules described below may be implemented as hardware modules, software modules, or a combination of hardware modules and software modules.

According to an embodiment, the processor (e.g., 120 of FIG. 1) of the electronic device 200 or software (e.g., program 140) executed by the processor (e.g., 120 of FIG. 1) may include a shortcut key detection module. The “shortcut key detection module” may be a module that detects a shortcut key (e.g., hardware key or software key) input. A shortcut key may be a key designated for displaying information (e.g., information related to a component (e.g., port or camera) of the electronic device 200, or an icon corresponding to the information) on a screen. There is no limitation on the type or definition of shortcut keys. The electronic device 200 may identify a shortcut key input through the shortcut key detection module. The electronic device 200 may display information (e.g., information related to a component (e.g., port or camera) of the electronic device 200, or an icon corresponding to the information) on a screen based on identifying the shortcut key input. There is no limitation on how the electronic device 200 identifies the shortcut key input.

According to an embodiment, the processor (e.g., 120 of FIG. 1) of the electronic device 200 or software (e.g., program 140) executed by the processor (e.g., 120 of FIG. 1) may include a gesture detection module. The “gesture detection module” may be a module that detects a gesture (e.g., four-finger swipe or air gesture) input. A gesture may be a gesture designated for displaying information (e.g., information related to a component (e.g., port or camera) of the electronic device 200, or an icon corresponding to the information) on a screen. There is no limitation on the type or definition of gestures. The electronic device 200 may identify a gesture input through the gesture detection module. The electronic device 200 may display information (e.g., information related to a component (e.g., port or camera) of the electronic device 200) on a screen based on identifying the gesture input. There is no limitation on how the electronic device 200 identifies the gesture input.

According to an embodiment, the processor (e.g., 120 of FIG. 1) of the electronic device 200 or software (e.g., program 140) executed by the processor (e.g., 120 of FIG. 1) may include a tilt detection module. The “tilt detection module” may be a module that detects a tilt of the electronic device 200. For example, the tilt detection module may detect the tilt of the electronic device 200 using the sensor module 176 of FIG. 1 (e.g., gyroscope sensor, acceleration sensor). There is no limitation on the type of at least one sensor included in the sensor module 176 used to detect the tilt of the electronic device 200. The electronic device 200 may identify the tilt of the electronic device 200 through the tilt detection module. The electronic device 200 may display information (e.g., information related to a component (e.g., port or camera) of the electronic device 200, or an icon corresponding to the information) on a screen based on identifying the tilt of the electronic device 200 (e.g., angle tilted upward, downward, leftward, and/or rightward). There is no limitation on how the electronic device 200 identifies the tilt. According to an embodiment, the electronic device 200 may perform a specific operation based on a tilted angle identified through the tilt detection module being greater than or equal to a reference angle.

According to an embodiment, the processor (e.g., 120 of FIG. 1) of the electronic device 200 or software (e.g., program 140) executed by the processor (e.g., 120 of FIG. 1) may include a side touch detection module. The “side touch detection module” may be a module that detects a touch of the side surface 211; 212; 213; 214; 215; 216 of the electronic device 200. For example, the side touch detection module may detect a touch of the side surface 211; 212; 213; 214; 215; 216 of the electronic device 200 using the sensor module 176 of FIG. 1. There is no limitation on the type of at least one sensor included in the sensor module 176 used to detect the touch of the side surface 211; 212; 213; 214; 215; 216 of the electronic device 200. The electronic device 200 may identify the touch of the side surface 211; 212; 213; 214; 215; 216 of the electronic device 200 through the side touch detection module. The electronic device 200 may display information (e.g., information related to a component (e.g., port or camera) of the electronic device 200, or an icon corresponding to the information) on a screen based on identifying the touch of the side surface 211; 212; 213; 214; 215; 216 of the electronic device 200. There is no limitation on how the electronic device 200 identifies the side touch. According to an embodiment, the electronic device 200 may perform a specific operation based on a touch range identified through the side touch detection module being greater than or equal to a reference range.

According to an embodiment, the processor (e.g., 120 of FIG. 1) of the electronic device 200 or software (e.g., program 140) executed by the processor (e.g., 120 of FIG. 1) may include a border touch detection module. The “border touch detection module” may be a module that detects a touch of a border of the display (e.g., display module 160 or foldable display 230) of the electronic device 200. A border touch may be a touch on the border of the display (e.g., display module 160 or foldable display 230). For example, the border touch detection module may detect a touch of the border of the display (e.g., display module 160 or foldable display 230) of the electronic device 200 using the sensor module 176 or display module 160 of FIG. 1. There is no limitation on the type of at least one sensor (e.g., touch screen panel, digitizer, touch sensor) included in the sensor module 176 or display module 160 used to detect the touch of the border of the display (e.g., display module 160 or foldable display 230) of the electronic device 200. The electronic device 200 may identify the touch of the border of the display (e.g., display module 160 or foldable display 230) of the electronic device 200 through the border touch detection module. The electronic device 200 may display information (e.g., information related to a component (e.g., port or camera) of the electronic device 200, or an icon corresponding to the information) on a screen based on identifying the touch of the border of the display (e.g., display module 160 or foldable display 230) of the electronic device 200. There is no limitation on how the electronic device 200 identifies the border touch. According to an embodiment, the electronic device 200 may perform a specific operation based on a touch range identified through the border touch detection module being greater than or equal to a reference range.

According to an embodiment, the electronic device 200 may also identify both a touch of the side surface 211; 212; 213; 214; 215; 216 of the electronic device 200 and a touch of the border of the display (e.g., display module 160 or foldable display 230) of the electronic device 200 through the side touch detection module and the border touch detection module.

According to an embodiment, the processor (e.g., 120 of FIG. 1) of the electronic device 200 or software (e.g., program 140) executed by the processor (e.g., 120 of FIG. 1) may include a port connection detection module. The “port connection detection module” may be a module that detects a connection state (e.g., connected or disconnected) of the plurality of ports 601; 602; 603; 604; 605; 606; 607; 608; 611; 612; 613 of the electronic device 200. For example, the port connection detection module may detect the connection state (e.g., connected or disconnected) of the plurality of ports 601; 602; 603; 604; 605; 606; 607; 608; 611; 612; 613 of the electronic device 200 using the sensor module 176 of FIG. 1. There is no limitation on the type of at least one sensor included in the sensor module 176 used to detect the connection state (e.g., connected or disconnected) of the plurality of ports 601; 602; 603; 604; 605; 606; 607; 608; 611; 612; 613 of the electronic device 200. For example, the port connection detection module may detect the connection state (e.g., connected or disconnected) of the plurality of ports 601; 602; 603; 604; 605; 606; 607; 608; 611; 612; 613 through communication with an external device (e.g., power source, earphones, universal serial bus (USB) device, micro secure digital (SD)) connected to the plurality of ports 601; 602; 603; 604; 605; 606; 607; 608; 611; 612; 613 of the electronic device 200. The electronic device 200 may identify the connection state (e.g., connected or disconnected) of the plurality of ports 601; 602; 603; 604; 605; 606; 607; 608; 611; 612; 613 through the port connection detection module. The electronic device 200 may display information (e.g., information related to a component (e.g., port or camera) of the electronic device 200, or an icon corresponding to the information) on a screen based on identifying the connection state (e.g., connected or disconnected) of the plurality of ports 601; 602; 603; 604; 605; 606; 607; 608; 611; 612; 613 of the electronic device 200. There is no limitation on how the electronic device 200 identifies the connection state (e.g., connected or disconnected) of the plurality of ports 601; 602; 603; 604; 605; 606; 607; 608; 611; 612; 613.

According to an embodiment, the processor (e.g., 120 of FIG. 1) of the electronic device 200 or software (e.g., program 140) executed by the processor (e.g., 120 of FIG. 1) may include a detection enhancement module. The “detection enhancement module” may be a module that updates reference values (e.g., reference angle or reference range) related to the tilt detection module, side touch detection module, and border touch detection module.

Operations through various modules included in the processor (e.g., 120 of FIG. 1) of the electronic device 200 or software (e.g., program 140) executed by the processor (e.g., 120 of FIG. 1) is described below.

At least some of the operations of FIG. 5 may be omitted. The order of operations of FIG. 5 may be changed. Operations other than the operations of FIG. 5 may be performed before, while, or after performing the operations of FIG. 5.

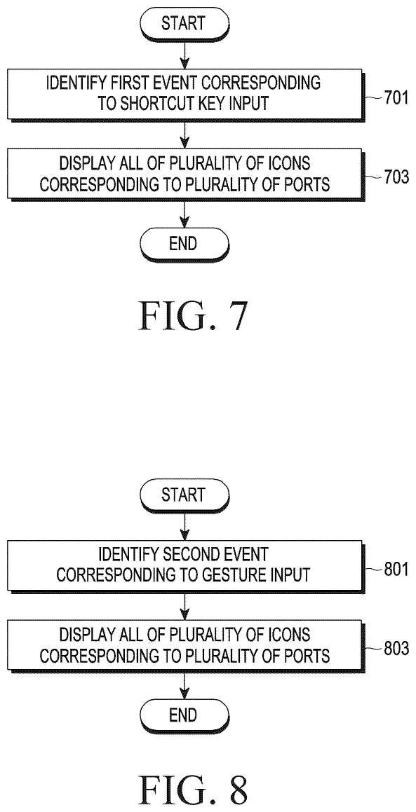

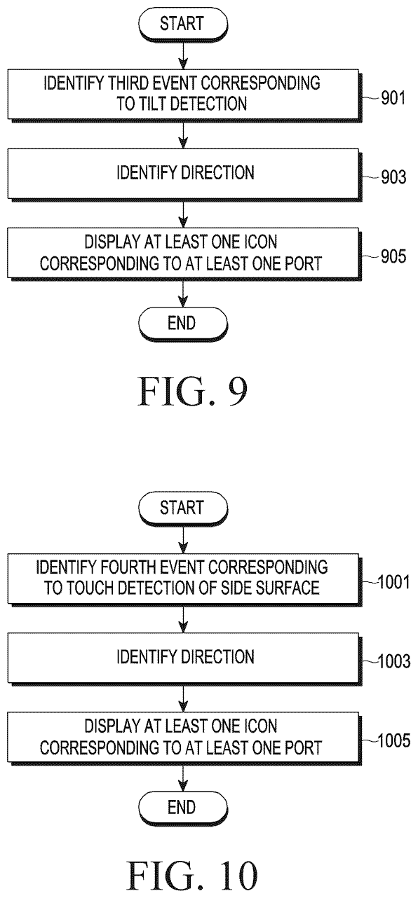

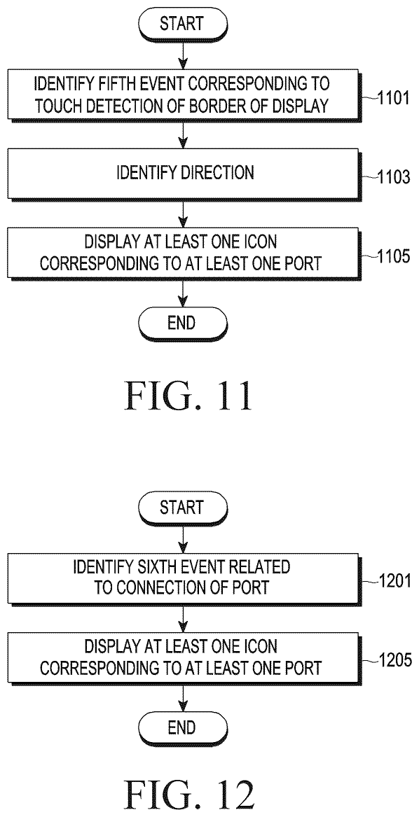

Referring to FIG. 5, in operation 501, according to an embodiment, the electronic device 200 (e.g., the processor 120) may identify at least one event. The at least one event may be an event that causes display of information related to a component (e.g., port or camera) of the electronic device 200 (or an icon corresponding to information related to the component (e.g., port or camera)). For example, the electronic device 200 may display information of a component (e.g., port or camera) of the electronic device 200 (or an icon corresponding to information related to the component (e.g., port or camera)) on a screen according to identifying the at least one event. The at least one event may be at least one of a first event, a second event, a third event, a fourth event, a fifth event, or a sixth event. The first event may correspond to a shortcut key input. The second event may correspond to a gesture input. The third event may correspond to tilt detection. The fourth event may correspond to touch detection of the side surface (e.g., side surfaces 211, 215, 216 of the first housing 201 or side surfaces 212, 213, 214 of the second housing 202) of the housing. The fifth event may correspond to touch detection of a border of the display (e.g., foldable display 230). The sixth event may correspond to a connection state (e.g., connected or disconnected) of at least one port 601; 602; 603; 604; 605; 606; 607; 608; 611; 612; 613. The first event is described in detail with reference to FIG. 7. The second event is described in detail with reference to FIG. 8. The third event is described in detail with reference to FIG. 9. The fourth event is described in detail with reference to FIG. 10. The fifth event is described in detail with reference to FIG. 11. The sixth event is described in detail with reference to FIG. 12.

In operation 503, according to an embodiment, the electronic device 200 (e.g., the processor 120) may obtain information related to at least one port (e.g., 601; 602; 603; 604; 605; 606; 607; 608; 611; 612; 613). For example, the electronic device 200 may obtain information related to at least one port (e.g., 601; 602; 603; 604; 605; 606; 607; 608; 611; 612; 613) from a server (e.g., server 108). For example, the electronic device 200 may identify information related to at least one port (e.g., 601; 602; 603; 604; 605; 606; 607; 608; 611; 612; 613) stored in memory (e.g., memory 130). The “information related to at least one port (e.g., 601; 602; 603; 604; 605; 606; 607; 608; 611; 612; 613)” may include position information, connection information, and/or additional information. The “position information” may be information corresponding to a position where at least one port (e.g., 601; 602; 603; 604; 605; 606; 607; 608; 611; 612; 613) is disposed. The “connection information” may be information corresponding to a connection state (e.g., connected or disconnected) of an external device to at least one port (e.g., 601; 602; 603; 604; 605; 606; 607; 608; 611; 612; 613). The “additional information” may be information related to an external device connected to at least one port (e.g., 601; 602; 603; 604; 605; 606; 607; 608; 611; 612; 613) (e.g., ID of the external device, type of the external device, specifications of the external device, manufacturer of the external device, state of the electronic device 200 related to the external device). According to an embodiment, the electronic device 200 may identify a port (e.g., 601; 602; 603; 604; 605; 606; 607; 608; 611; 612; 613) for which to display port information (or an icon corresponding to port information) on a screen, and may obtain information corresponding to the identified port (e.g., 601; 602; 603; 604; 605; 606; 607; 608; 611; 612; 613). According to an embodiment, the electronic device 200 may obtain information corresponding to all ports (e.g., 601; 602; 603; 604; 605; 606; 607; 608; 611; 612; 613). Operation 503 may be performed after operation 501 is performed, or may be performed before performing operation 501.

In operation 505, according to an embodiment, the electronic device 200 (e.g., the processor 120) may display at least one icon corresponding to at least one port (e.g., 601; 602; 603; 604; 605; 606; 607; 608; 611; 612; 613) based on the at least one event. The “at least one icon” may be an icon representing information corresponding to at least one port (e.g., 601; 602; 603; 604; 605; 606; 607; 608; 611; 612; 613). For example, the at least one icon may represent position information of at least one port (e.g., 601; 602; 603; 604; 605; 606; 607; 608; 611; 612; 613). For example, the at least one icon may represent connection information of at least one port (e.g., 601; 602; 603; 604; 605; 606; 607; 608; 611; 612; 613). For example, the at least one icon may represent additional information of at least one port (e.g., 601; 602; 603; 604; 605; 606; 607; 608; 611; 612; 613). According to an embodiment, in FIG. 6, the electronic device 200 (e.g., the processor 120) may display at least one icon 621; 622; 623; 624; 625; 626; 627; 628; 631; 632; 633; 641; 642; 643; 644; 645; 646; 647; 648; 651; 652; 653; 663; 664; 666 corresponding to at least one port 601; 602; 603; 604; 605; 606; 607; 608; 611; 612; 613 based on at least one event. In FIG. 6, the first port 601 may be disposed on the first side surface 211 of the electronic device 200. The icon 621 may be an icon indicating the position of the first port 601. The icon 641 may be an icon indicating information of the first port 601. The icon 641 may be an icon indicating the type (e.g., Thunderbolt) of the first port 601. The icon 641 may be an icon indicating the connection state (e.g., connected or disconnected) of the first port 601. For example, a characteristic (e.g., color) of the icon 641 may correspond to the connection state (e.g., connected or disconnected) of the first port 601. The icon 621 and the icon 641 may be displayed in the first area 231 corresponding to the position of the first port 601 among the plurality of areas (e.g., 231, 232, 233, 234) of the display (e.g., foldable display 230). In FIG. 6, the second port 602 may be disposed on the first side surface 211 of the electronic device 200. The icon 622 may be an icon indicating the position of the second port 602. The icon 642 may be an icon indicating information of the second port 602. The icon 642 may be an icon indicating the type (e.g., USB-C) of the second port 602. The icon 642 may be an icon indicating the connection state (e.g., connected or disconnected) of the second port 602. For example, a characteristic (e.g., color) of the icon 642 may correspond to the connection state (e.g., connected or disconnected) of the second port 602. The icon 622 and the icon 642 may be displayed in the first area 231 corresponding to the position of the second port 602 among the plurality of areas (e.g., 231, 232, 233, 234) of the display (e.g., foldable display 230). In FIG. 6, the third port 603 may be disposed on the first side surface 211 of the electronic device 200. The icon 623 may be an icon indicating the position of the third port 603. The icon 643 may be an icon indicating information of the third port 603. For example, the icon 643 may indicate the type (e.g., USB-A 3.0) of the third port 603. For example, the icon 643 may indicate the connection state (e.g., connected) of the third port 603. For example, a characteristic (e.g., color) of the icon 643 may correspond to the connection state (e.g., connected) of the third port 603. The icon 663 may be an icon indicating information of the third port 603. For example, the icon 663 may indicate information about an external device connected to the third port 603 (e.g., ID, type, specifications, manufacturer of the external device, state of the electronic device 200 related to the external device) (e.g., “External HDD (Samsung 1 TB)”). The icon 623 and the icon 643 may be displayed in the first area 231 corresponding to the position of the third port 603 among the plurality of areas (e.g., 231, 232, 233, 234) of the display (e.g., foldable display 230). In FIG. 6, the fourth port 604 may be disposed on the first side surface 211 of the electronic device 200. The icon 624 may be an icon indicating the position of the fourth port 604. The icon 644 may be an icon indicating information of the fourth port 604. For example, the icon 644 may indicate the type (e.g., USB-A 2.0) of the fourth port 604. For example, the icon 644 may indicate the connection state (e.g., connected) of the fourth port 604. For example, a characteristic (e.g., color) of the icon 644 may correspond to the connection state (e.g., connected) of the fourth port 604. The icon 664 may be an icon indicating information of the fourth port 604. For example, the icon 664 may indicate information about an external device connected to the fourth port 604 (e.g., ID, type, specifications, manufacturer of the external device, state of the electronic device 200 related to the external device) (e.g., “USB multi-hub”). The icon 624 and the icon 644 may be displayed in the first area 231 corresponding to the position of the fourth port 604 among the plurality of areas (e.g., 231, 232, 233, 234) of the display (e.g., foldable display 230). In FIG. 6, the fifth port 605 may be disposed on the second side surface 212 of the electronic device 200. The icon 625 may be an icon indicating the position of the fifth port 605. The icon 645 may be an icon indicating information of the fifth port 605. For example, the icon 645 may indicate the type (e.g., USB-C) of the fifth port 605. For example, the icon 645 may indicate the connection state (e.g., connected or disconnected) of the fifth port 605. For example, a characteristic (e.g., color) of the icon 645 may correspond to the connection state (e.g., connected or disconnected) of the fifth port 605. The icon 625 and the icon 645 may be displayed in the third area 233 corresponding to the position of the fifth port 605 among the plurality of areas (e.g., 231, 232, 233, 234) of the display (e.g., foldable display 230). In FIG. 6, the sixth port 606 may be disposed on the second side surface 212 of the electronic device 200. The icon 626 may be an icon indicating the position of the sixth port 606. The icon 646 may be an icon indicating information of the sixth port 606. For example, the icon 646 may indicate the type (e.g., USB-C) of the sixth port 606. For example, the icon 646 may indicate the connection state (e.g., connected) of the sixth port 606. For example, a characteristic (e.g., color) of the icon 646 may correspond to the connection state (e.g., connected) of the sixth port 606. For example, a characteristic (e.g., color) of the icon 646 indicating the connection state (e.g., connected) of the sixth port 606 may be different from a characteristic (e.g., color) of the icon 645 indicating the connection state (e.g., connected or disconnected) of the fifth port 605. The icon 666 may be an icon indicating information of the sixth port 606. For example, the icon 666 may indicate information about an external device connected to the sixth port 606 (e.g., ID, type, specifications, manufacturer of the external device, state of the electronic device 200 related to the external device) (e.g., “Plug connected (15 minutes remaining to full charge)”). The icon 626 and the icon 646 may be displayed in the third area 233 corresponding to the position of the sixth port 606 among the plurality of areas (e.g., 231, 232, 233, 234) of the display (e.g., foldable display 230). In FIG. 6, the seventh port 607 may be disposed on the fourth side surface 214 of the electronic device 200. The icon 627 may be an icon indicating the position of the seventh port 607. The icon 647 may be an icon indicating information of the seventh port 607. For example, the icon 647 may indicate the type (e.g., USB-C) of the seventh port 607. For example, the icon 647 may indicate the connection state (e.g., connected or disconnected) of the seventh port 607. For example, a characteristic (e.g., color) of the icon 647 may correspond to the connection state (e.g., connected or disconnected) of the seventh port 607. The icon 627 and the icon 647 may be displayed in the fourth area 234 corresponding to the position of the seventh port 607 among the plurality of areas (e.g., 231, 232, 233, 234) of the display (e.g., foldable display 230). In FIG. 6, the eighth port 608 may be disposed on the fourth side surface 214 of the electronic device 200. The icon 628 may be an icon indicating the position of the eighth port 608. The icon 648 may be an icon indicating information of the eighth port 608. For example, the icon 648 may indicate the type (e.g., USB-C) of the eighth port 608. For example, the icon 648 may indicate the connection state (e.g., connected or disconnected) of the eighth port 608. For example, a characteristic (e.g., color) of the icon 648 may correspond to the connection state (e.g., connected or disconnected) of the eighth port 608. The icon 628 and the icon 648 may be displayed in the fourth area 234 corresponding to the position of the eighth port 608 among the plurality of areas (e.g., 231, 232, 233, 234) of the display (e.g., foldable display 230). In FIG. 6, the eleventh port 611 may be disposed on the fifth side surface 215 of the electronic device 200. The icon 631 may be an icon indicating the position of the eleventh port 611. The icon 651 may be an icon indicating information of the eleventh port 611. For example, the icon 651 may indicate the type (e.g., micro SD) of the eleventh port 611. For example, the icon 651 may indicate the connection state (e.g., connected or disconnected) of the eleventh port 611. For example, a characteristic (e.g., color) of the icon 651 may correspond to the connection state (e.g., connected or disconnected) of the eleventh port 611. The icon 631 and the icon 651 may be displayed in the second area 232 corresponding to the position of the eleventh port 611 among the plurality of areas (e.g., 231, 232, 233, 234) of the display (e.g., foldable display 230). In FIG. 6, the twelfth port 612 may be disposed on the fifth side surface 215 of the electronic device 200. The icon 632 may be an icon indicating the position of the twelfth port 612. The icon 652 may be an icon indicating information of the twelfth port 612. For example, the icon 652 may indicate the type (e.g., high-definition multimedia interface (HDMI)) of the twelfth port 612. For example, the icon 652 may indicate the connection state (e.g., connected or disconnected) of the twelfth port 612. For example, a characteristic (e.g., color) of the icon 652 may correspond to the connection state (e.g., connected or disconnected) of the twelfth port 612. The icon 632 and the icon 652 may be displayed in the second area 232 corresponding to the position of the twelfth port 612 among the plurality of areas (e.g., 231, 232, 233, 234) of the display (e.g., foldable display 230). In FIG. 6, the thirteenth port 613 may be disposed on the fifth side surface 215 of the electronic device 200. The icon 633 may be an icon indicating the position of the thirteenth port 613. The icon 653 may be an icon indicating information of the thirteenth port 613. For example, the icon 653 may indicate the type (e.g., 3.5 mm stereo jack) of the thirteenth port 613. For example, the icon 653 may indicate the connection state (e.g., connected or disconnected) of the thirteenth port 613. For example, a characteristic (e.g., color) of the icon 653 may correspond to the connection state (e.g., connected or disconnected) of the thirteenth port 613. The icon 633 and the icon 653 may be displayed in the second area 232 corresponding to the position of the thirteenth port 613 among the plurality of areas (e.g., 231, 232, 233, 234) of the display (e.g., foldable display 230). In FIG. 6, the camera 609 may be disposed at a position corresponding to an area of the display (e.g., foldable display 230) of the electronic device 200. The icon 629 may be an icon indicating the position of the camera 609. The icon 649 may be an icon indicating information of the camera 609. For example, the icon 649 may indicate the type of the camera 609. For example, the icon 649 may indicate an operation state of the camera 609. For example, a characteristic (e.g., color) of the icon 649 may correspond to the operation state of the camera 609. The icon 669 may be an icon indicating information of the camera 609 (e.g., “Being used in camera app.”).

According to embodiments described below, at least one icon among the icons 621; 622; 623; 624; 625; 626; 627; 628; 631; 632; 633; 641; 642; 643; 644; 645; 646; 647; 648; 651; 652; 653; 663; 664; 666 corresponding to the plurality of ports 601; 602; 603; 604; 605; 606; 607; 608; 611; 612; 613 and the icons 629; 649; 669 corresponding to the camera 609 of FIG. 6 may be displayed.

FIG. 7 is a flowchart illustrating an operation method of an electronic device, according to an embodiment of the disclosure. FIG. 7 may be described with reference to the above-described embodiment.

At least some of the operations of FIG. 7 may be omitted. The operation order of the operations of FIG. 7 may be changed. Operations other than the operations of FIG. 7 may be performed before, while, or after performing the operations of FIG. 7.

Referring to FIG. 7, in operation 701, according to an embodiment, the electronic device 200 (e.g., the processor 120) may identify a first event corresponding to a shortcut key input. The electronic device 200 may identify the first event corresponding to the shortcut key input as the at least one event of operation 501 of FIG. 5.

In operation 703, according to an embodiment, the electronic device 200 (e.g., the processor 120) may display all of a plurality of icons 621; 622; 623; 624; 625; 626; 627; 628; 631; 632; 633; 641; 642; 643; 644; 645; 646; 647; 648; 651; 652; 653; 663; 664; 666 corresponding to the plurality of ports 601; 602; 603; 604; 605; 606; 607; 608; 611; 612; 613 of the electronic device 200 based on identifying the first event corresponding to the shortcut key input. The electronic device 200 may display icons 629, 649, 669 corresponding to the camera 609 based on identifying the first event corresponding to the shortcut key input. The electronic device 200 may display the screen of FIG. 6 based on identifying the first event corresponding to the shortcut key input.

FIG. 8 is a flowchart illustrating an operation method of an electronic device, according to an embodiment of the disclosure. FIG. 8 may be described with reference to the above-described embodiment.

At least some of the operations of FIG. 8 may be omitted. The operation order of the operations of FIG. 8 may be changed. Operations other than the operations of FIG. 8 may be performed before, while, or after performing the operations of FIG. 8.

Referring to FIG. 8, in operation 801, according to an embodiment, the electronic device 200 (e.g., the processor 120) may identify a second event corresponding to a gesture input. The electronic device 200 may identify the second event corresponding to the gesture input as the at least one event of operation 501 of FIG. 5.

In operation 803, according to an embodiment, the electronic device 200 (e.g., the processor 120) may display all of a plurality of icons 621; 622; 623; 624; 625; 626; 627; 628; 631; 632; 633; 641; 642; 643; 644; 645; 646; 647; 648; 651; 652; 653; 663; 664; 666 corresponding to the plurality of ports 601; 602; 603; 604; 605; 606; 607; 608; 611; 612; 613 of the electronic device 200 based on identifying the second event corresponding to the gesture input. The electronic device 200 may display icons 629, 649, 669 corresponding to the camera 609 based on identifying the second event corresponding to the gesture input. The electronic device 200 may display the screen of FIG. 6 based on identifying the second event corresponding to the gesture input.

FIG. 9 is a flowchart illustrating an operation method of an electronic device, according to an embodiment of the disclosure. FIG. 9 may be described with reference to the above-described embodiment.

At least some of the operations of FIG. 9 may be omitted. The operation order of the operations of FIG. 9 may be changed. Operations other than the operations of FIG. 9 may be performed before, while, or after performing the operations of FIG. 9.

Referring to FIG. 9, in operation 901, according to an embodiment, the electronic device 200 (e.g., the processor 120) may identify a third event corresponding to tilt detection. The electronic device 200 may identify the third event corresponding to tilt detection as the at least one event of operation 501 of FIG. 5.

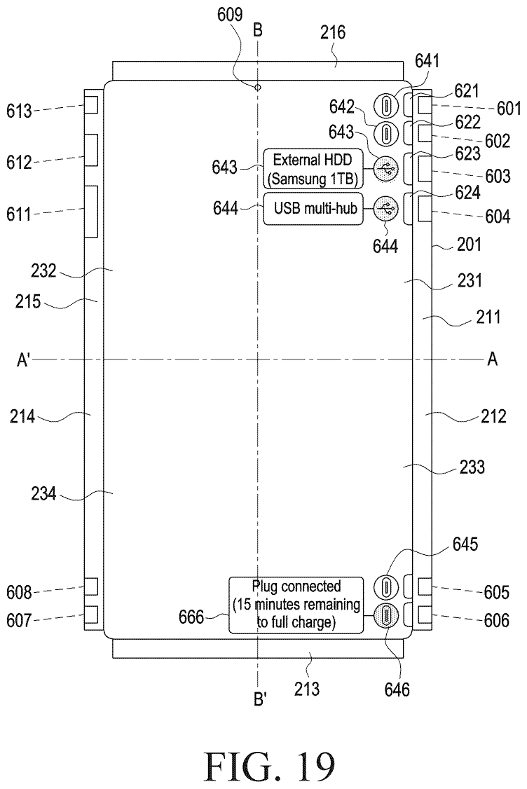

In operation 903, according to an embodiment, the electronic device 200 (e.g., the processor 120) may identify a direction corresponding to the third event based on identifying the third event corresponding to tilt detection. According to an embodiment, “direction” may include “position”. For example, “direction” may include upper, lower, left, right, upper left, lower left, upper right, and lower right. Direction may be relatively determined according to an arrangement direction of the electronic device 200. For example, when the electronic device 200 is disposed horizontally as in FIG. 6, the upper side of the electronic device 200 may correspond to the first side surface 211 and the second side surface 212, but when the electronic device 200 is disposed vertically as in FIG. 19 described below, the upper side of the electronic device 200 may correspond to the sixth side surface 216. The electronic device 200 may identify a direction corresponding to an event to determine a port for which to display port information based on the event. For example, when a user tilts the electronic device 200 to the right, the electronic device 200 may identify the right as a direction corresponding to the third event. For example, when a user tilts the electronic device 200 to the left, the electronic device 200 may identify the left as a direction corresponding to the third event. For example, when a user tilts the electronic device 200 downward, the electronic device 200 may identify the lower side as a direction corresponding to the third event. For example, when a user tilts the electronic device 200 upward, the electronic device 200 may identify the upper side as a direction corresponding to the third event. An actual tilted direction and a direction identified in response to the tilt may correspond one-to-one or may correspond one-to-two. For example, when a user tilts the electronic device 200 to the left or right, the electronic device 200 may identify left and right as directions corresponding to the third event. For example, when a user tilts the electronic device 200 upward or downward, the electronic device 200 may identify upper and lower as directions corresponding to the third event. For example, when a user tilts the electronic device 200 upward and to the right, the electronic device 200 may identify upper right as a direction corresponding to the third event. For example, when a user tilts the electronic device 200 upward and to the left, the electronic device 200 may identify upper left as a direction corresponding to the third event. For example, when a user tilts the electronic device 200 downward and to the right, the electronic device 200 may identify lower right as a direction corresponding to the third event. For example, when a user tilts the electronic device 200 downward and to the left, the electronic device 200 may identify lower left as a direction corresponding to the third event. According to an embodiment, the electronic device 200 (e.g., the processor 120) may identify a direction corresponding to the third event based on a reference angle. The electronic device 200 may identify at least one tilt angle of the electronic device 200 corresponding to the third event based on identifying the third event corresponding to tilt detection. For example, the at least one tilt angle of the electronic device 200 may include a tilt angle upward, a tilt angle downward, a tilt angle to the left, and a tilt angle to the right. The electronic device 200 may identify a direction corresponding to the third event by comparing the at least one tilt angle of the electronic device 200 with at least one reference angle. For example, the electronic device 200 may identify the upper side as a direction corresponding to the third event based on the upward tilt angle being greater than or equal to a first reference angle corresponding to the upper side. For example, the electronic device 200 may identify the lower side as a direction corresponding to the third event based on the downward tilt angle being greater than or equal to a second reference angle corresponding to the lower side. For example, the electronic device 200 may identify the left as a direction corresponding to the third event based on the leftward tilt angle being greater than or equal to a third reference angle corresponding to the left. For example, the electronic device 200 may identify the right as a direction corresponding to the third event based on the rightward tilt angle being greater than or equal to a fourth reference angle corresponding to the right. For example, the electronic device 200 may identify the upper left as a direction corresponding to the third event based on the upward tilt angle being greater than or equal to a first reference angle corresponding to the upper side and the leftward tilt angle being greater than or equal to a third reference angle corresponding to the left. For example, the electronic device 200 may identify the upper right as a direction corresponding to the third event based on the upward tilt angle being greater than or equal to a first reference angle corresponding to the upper side and the rightward tilt angle being greater than or equal to a fourth reference angle corresponding to the right. For example, the electronic device 200 may identify the lower left as a direction corresponding to the third event based on the downward tilt angle being greater than or equal to a second reference angle corresponding to the lower side and the leftward tilt angle being greater than or equal to a third reference angle corresponding to the left. For example, the electronic device 200 may identify the lower right as a direction corresponding to the third event based on the downward tilt angle being greater than or equal to a second reference angle corresponding to the lower side and the rightward tilt angle being greater than or equal to a fourth reference angle corresponding to the right.

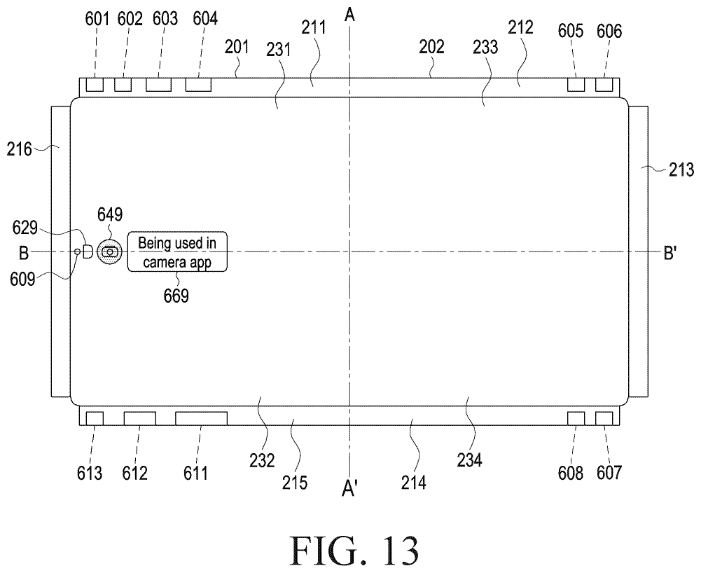

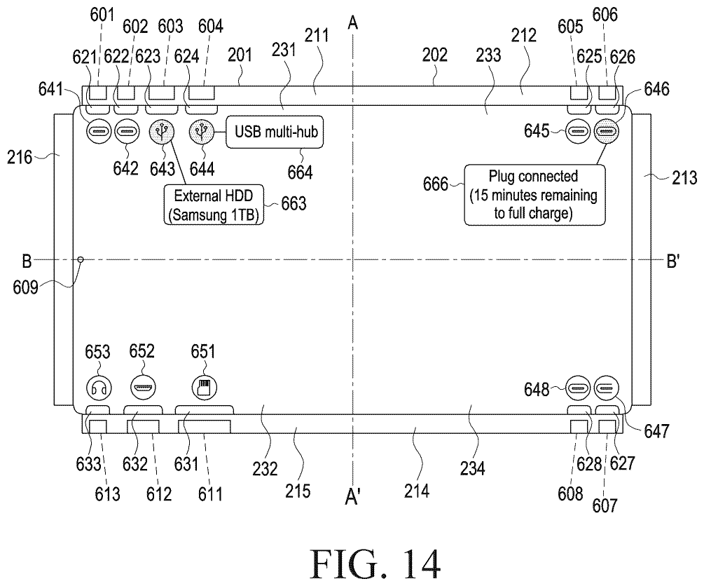

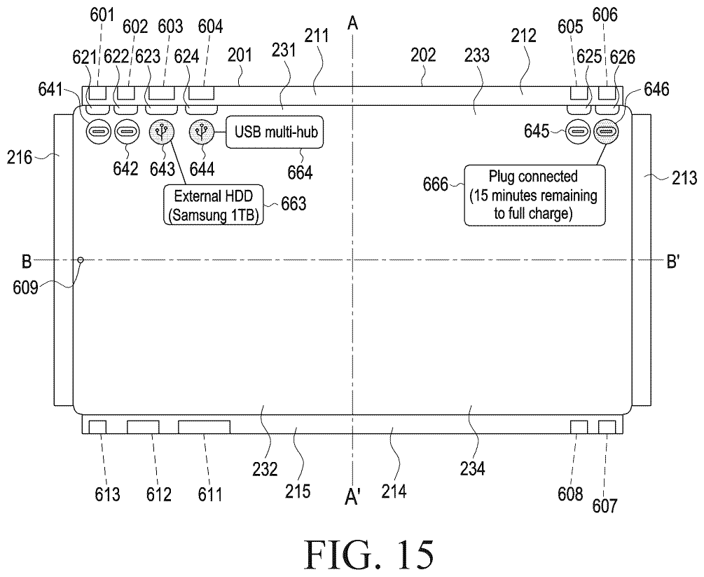

In operation 905, according to an embodiment, the electronic device 200 (e.g., the processor 120) may display at least one icon corresponding to at least one port among the plurality of ports 601; 602; 603; 604; 605; 606; 607; 608; 611; 612; 613 of the electronic device 200 based on a direction corresponding to the third event. The electronic device 200 may display at least one icon corresponding to the camera 609 based on the direction corresponding to the third event. For example, as in FIG. 15 described below, the electronic device 200 may display at least one icon 621; 622; 623; 624; 625; 626; 641; 642; 643; 644; 645; 646; 663; 664; 666 corresponding to at least one port 601; 602; 603; 604; 605; 606 corresponding to the upper side among the plurality of ports 601; 602; 603; 604; 605; 606; 607; 608; 611; 612; 613 based on identifying the upper side as the direction corresponding to the third event. For example, as in FIG. 14 described below, the electronic device 200 may display at least one icon 621; 622; 623; 624; 625; 626; 627; 628; 631; 632; 633; 641; 642; 643; 644; 645; 646; 647; 648; 651; 652; 653; 663; 664; 666 corresponding to at least one port 601; 602; 603; 604; 605; 606; 607; 608; 611; 612; 613 corresponding to the upper side and lower side among the plurality of ports 601; 602; 603; 604; 605; 606; 607; 608; 611; 612; 613 based on identifying the upper side and lower side as directions corresponding to the third event. For example, as in FIG. 13 described below, the electronic device 200 may display at least one icon 629; 649; 669 corresponding to the camera 609 based on identifying the left as the direction corresponding to the third event. The electronic device 200 may not display an icon corresponding to a port based on there being no port corresponding to the left identified as the direction corresponding to the third event.

FIG. 10 is a flowchart illustrating an operation method of an electronic device, according to an embodiment of the disclosure. FIG. 10 may be described with reference to the above-described embodiment.

At least some of the operations of FIG. 10 may be omitted. The operation order of the operations of FIG. 10 may be changed. Operations other than the operations of FIG. 10 may be performed before, while, or after performing the operations of FIG. 10.

Referring to FIG. 10, in operation 1001, according to an embodiment, the electronic device 200 (e.g., the processor 120) may identify a fourth event corresponding to touch detection of the side surface 211, 212, 213, 214, 215, 216. The electronic device 200 may identify the fourth event corresponding to touch detection of the side surface as the at least one event of operation 501 of FIG. 5.

In operation 1003, according to an embodiment, the electronic device 200 (e.g., the processor 120) may identify a direction corresponding to the fourth event based on identifying the fourth event corresponding to touch detection of the side surface 211, 212, 213, 214, 215, 216. According to an embodiment, “direction” may include “position”. For example, “direction” may include upper, lower, left, right, upper left, lower left, upper right, and lower right. Direction may be relatively determined according to an arrangement direction of the electronic device 200. For example, when the electronic device 200 is disposed horizontally as in FIG. 6, the upper side of the electronic device 200 may correspond to the first side surface 211 and the second side surface 212, but when the electronic device 200 is disposed vertically as in FIG. 19 described below, the upper side of the electronic device 200 may correspond to the sixth side surface 216. The electronic device 200 may identify a direction corresponding to an event to determine a port for which to display port information based on the event. For example, based on touch detection of a right side surface of the housing (e.g., 201; 202), the electronic device 200 may identify the right as a direction corresponding to the fourth event. For example, based on touch detection of a left side surface of the housing (e.g., 201; 202), the electronic device 200 may identify the left as a direction corresponding to the fourth event. For example, based on touch detection of a lower side surface of the housing (e.g., 201; 202), the electronic device 200 may identify the lower side as a direction corresponding to the fourth event. For example, based on touch detection of an upper side surface of the housing (e.g., 201; 202), the electronic device 200 may identify the upper side as a direction corresponding to the fourth event. An actual touch direction and a direction identified in response to the touch may correspond one-to-one or may correspond one-to-two. For example, based on touch detection of a left side surface or right side surface of the housing (e.g., 201; 202), the electronic device 200 may identify left and right as directions corresponding to the fourth event. For example, based on touch detection of an upper side surface or lower side surface of the housing (e.g., 201; 202), the electronic device 200 may identify upper and lower as directions corresponding to the fourth event. For example, based on touch detection of an upper side surface and right side surface of the housing (e.g., 201; 202), the electronic device 200 may identify upper right as a direction corresponding to the fourth event. For example, based on touch detection of an upper side surface and left side surface of the housing (e.g., 201; 202), the electronic device 200 may identify upper left as a direction corresponding to the fourth event. For example, based on touch detection of a lower side surface and right side surface of the housing (e.g., 201; 202), the electronic device 200 may identify lower right as a direction corresponding to the fourth event. For example, based on touch detection of a lower side surface and left side surface of the housing (e.g., 201; 202), the electronic device 200 may identify lower left as a direction corresponding to the fourth event. For example, based on touch detection of an upper right side surface (e.g., the first side surface 211 when the electronic device 200 is disposed vertically) of the housing (e.g., 201; 202), the electronic device 200 may identify upper right as a direction corresponding to the fourth event. For example, based on touch detection of an upper left side surface (e.g., the fifth side surface 215 when the electronic device 200 is disposed vertically) of the housing (e.g., 201; 202), the electronic device 200 may identify upper left as a direction corresponding to the fourth event. For example, based on touch detection of a lower right side surface (e.g., the second side surface 212 when the electronic device 200 is disposed vertically) of the housing (e.g., 201; 202), the electronic device 200 may identify lower right as a direction corresponding to the fourth event. For example, based on touch detection of a lower left side surface (e.g., the fourth side surface 214 when the electronic device 200 is disposed vertically) of the housing (e.g., 201; 202), the electronic device 200 may identify lower left as a direction corresponding to the fourth event. According to an embodiment, the electronic device 200 (e.g., the processor 120) may identify a direction corresponding to the fourth event based on a reference range. The electronic device 200 may identify at least one touch position of the fourth event based on identifying the fourth event corresponding to touch detection of the side surface 211, 212, 213, 214, 215, 216. The at least one touch position may include upper, lower, left, right, upper left, lower left, upper right, and lower right. The electronic device 200 may identify at least one touch range corresponding to the at least one touch position. The at least one touch range may include a touch range corresponding to the upper side, a touch range corresponding to the lower side, a touch range corresponding to the left, a touch range corresponding to the right, a touch range corresponding to the upper left, a touch range corresponding to the lower left, a touch range corresponding to the upper right, and a touch range corresponding to the lower right. The electronic device 200 may compare the at least one touch range with at least one reference range. The at least one reference range may include a reference range corresponding to the upper side, a reference range corresponding to the lower side, a reference range corresponding to the left, a reference range corresponding to the right, a reference range corresponding to the upper left, a reference range corresponding to the lower left, a reference range corresponding to the upper right, and a reference range corresponding to the lower right. Each reference range may be the same, different, or only partially the same. The electronic device 200 may identify a direction corresponding to the fourth event by comparing the at least one touch range with the at least one reference range. For example, the electronic device 200 may identify the upper side as a direction corresponding to the fourth event based on a touch range corresponding to the upper side being greater than or equal to a reference range corresponding to the upper side. For example, the electronic device 200 may identify the lower side as a direction corresponding to the fourth event based on a touch range corresponding to the lower side being greater than or equal to a reference range corresponding to the lower side. For example, the electronic device 200 may identify the left as a direction corresponding to the fourth event based on a touch range corresponding to the left being greater than or equal to a reference range corresponding to the left. For example, the electronic device 200 may identify the right as a direction corresponding to the fourth event based on a touch range corresponding to the right being greater than or equal to a reference range corresponding to the right. For example, the electronic device 200 may identify the upper left as a direction corresponding to the fourth event based on a touch range corresponding to the upper side being greater than or equal to a reference range corresponding to the upper side and a touch range corresponding to the left being greater than or equal to a reference range corresponding to the left. For example, the electronic device 200 may identify the upper right as a direction corresponding to the fourth event based on a touch range corresponding to the upper side being greater than or equal to a reference range corresponding to the upper side and a touch range corresponding to the right being greater than or equal to a reference range corresponding to the right. For example, the electronic device 200 may identify the lower left as a direction corresponding to the fourth event based on a touch range corresponding to the lower side being greater than or equal to a reference range corresponding to the lower side and a touch range corresponding to the left being greater than or equal to a reference range corresponding to the left. For example, the electronic device 200 may identify the lower right as a direction corresponding to the fourth event based on a touch range corresponding to the lower side being greater than or equal to a reference range corresponding to the lower side and a touch range corresponding to the right being greater than or equal to a reference range corresponding to the right. For example, the electronic device 200 may identify the upper left as a direction corresponding to the fourth event based on a touch range corresponding to the upper left being greater than or equal to a reference range corresponding to the upper left. For example, the electronic device 200 may identify the upper right as a direction corresponding to the fourth event based on a touch range corresponding to the upper right being greater than or equal to a reference range corresponding to the upper right. For example, the electronic device 200 may identify the lower left as a direction corresponding to the fourth event based on a touch range corresponding to the lower left being greater than or equal to a reference range corresponding to the lower left. For example, the electronic device 200 may identify the lower right as a direction corresponding to the fourth event based on a touch range corresponding to the lower right being greater than or equal to a reference range corresponding to the lower right.

In operation 1005, according to an embodiment, the electronic device 200 (e.g., the processor 120) may display at least one icon corresponding to at least one port among the plurality of ports 601; 602; 603; 604; 605; 606; 607; 608; 611; 612; 613 of the electronic device 200 based on a direction corresponding to the fourth event. The electronic device 200 may display at least one icon corresponding to the camera 609 based on the direction corresponding to the fourth event. For example, as in FIG. 15 described below, the electronic device 200 may display at least one icon 621; 622; 623; 624; 625; 626; 641; 642; 643; 644; 645; 646; 663; 664; 666 corresponding to at least one port 601; 602; 603; 604; 605; 606 corresponding to the upper side among the plurality of ports 601; 602; 603; 604; 605; 606; 607; 608; 611; 612; 613 based on identifying the upper side as the direction corresponding to the fourth event. For example, as in FIG. 14 described below, the electronic device 200 may display at least one icon 621; 622; 623; 624; 625; 626; 627; 628; 631; 632; 633; 641; 642; 643; 644; 645; 646; 647; 648; 651; 652; 653; 663; 664; 666 corresponding to at least one port 601; 602; 603; 604; 605; 606; 607; 608; 611; 612; 613 corresponding to the upper side and lower side among the plurality of ports 601; 602; 603; 604; 605; 606; 607; 608; 611; 612; 613 based on identifying the upper side and lower side as directions corresponding to the fourth event. For example, as in FIG. 13 described below, the electronic device 200 may display at least one icon 629; 649; 669 corresponding to the camera 609 based on identifying the left as the direction corresponding to the fourth event. The electronic device 200 may not display an icon corresponding to a port based on there being no port corresponding to the left identified as the direction corresponding to the fourth event.

FIG. 11 is a flowchart illustrating an operation method of an electronic device, according to an embodiment of the disclosure. FIG. 11 may be described with reference to the above-described embodiment.

At least some of the operations of FIG. 11 may be omitted. The operation order of the operations of FIG. 11 may be changed. Operations other than the operations of FIG. 11 may be performed before, while, or after performing the operations of FIG. 11.

Referring to FIG. 11, in operation 1101, according to an embodiment, the electronic device 200 (e.g., the processor 120) may identify a fifth event corresponding to touch detection of a border of the display (e.g., foldable display 230). The electronic device 200 may identify the fifth event corresponding to touch detection of the border of the display (e.g., foldable display 230) as the at least one event of operation 501 of FIG. 5.

In operation 1103, according to an embodiment, the electronic device 200 (e.g., the processor 120) may identify a direction corresponding to the fifth event based on identifying the fifth event corresponding to touch detection of the border of the display (e.g., foldable display 230). According to an embodiment, “direction” may include “position”. For example, “direction” may include upper, lower, left, right, upper left, lower left, upper right, and lower right. Direction may be relatively determined according to an arrangement direction of the electronic device 200. For example, when the electronic device 200 is disposed horizontally as in FIG. 6, the upper side of the electronic device 200 may correspond to the first side surface 211 and the second side surface 212, but when the electronic device 200 is disposed vertically as in FIG. 19 described below, the upper side of the electronic device 200 may correspond to the sixth side surface 216. The electronic device 200 may identify a direction corresponding to an event to determine a port for which to display port information based on the event. For example, based on touch detection of a right border of the display (e.g., foldable display 230), the electronic device 200 may identify the right as a direction corresponding to the fifth event. For example, based on touch detection of a left border of the display (e.g., foldable display 230), the electronic device 200 may identify the left as a direction corresponding to the fifth event. For example, based on touch detection of a lower border of the display (e.g., foldable display 230), the electronic device 200 may identify the lower side as a direction corresponding to the fifth event. For example, based on touch detection of an upper border of the display (e.g., foldable display 230), the upper side may be identified as a direction corresponding to the fifth event. An actual touch direction and a direction identified in response to the touch may correspond one-to-one or may correspond one-to-two. For example, based on touch detection of a left border or right border of the display (e.g., foldable display 230), the electronic device 200 may identify left and right as directions corresponding to the fifth event. For example, based on touch detection of an upper border or lower border of the display (e.g., foldable display 230), the electronic device 200 may identify upper and lower as directions corresponding to the fifth event. For example, based on touch detection of an upper border and right border of the display (e.g., foldable display 230), the electronic device 200 may identify upper right as a direction corresponding to the fifth event. For example, based on touch detection of an upper border and left border of the display (e.g., foldable display 230), the electronic device 200 may identify upper left as a direction corresponding to the fifth event. For example, based on touch detection of a lower border and right border of the display (e.g., foldable display 230), the electronic device 200 may identify lower right as a direction corresponding to the fifth event. For example, based on touch detection of a lower border and left border of the display (e.g., foldable display 230), the electronic device 200 may identify lower left as a direction corresponding to the fifth event. For example, based on touch detection of an upper right border (e.g., a border corresponding to the first side surface 211 when the electronic device 200 is disposed vertically) of the display (e.g., foldable display 230), the electronic device 200 may identify upper right as a direction corresponding to the fifth event. For example, based on touch detection of an upper left border (e.g., a border corresponding to the fifth side surface 215 when the electronic device 200 is disposed vertically) of the display (e.g., foldable display 230), the electronic device 200 may identify upper left as a direction corresponding to the fifth event. For example, based on touch detection of a lower right border (e.g., a border corresponding to the second side surface 212 when the electronic device 200 is disposed vertically) of the display (e.g., foldable display 230), the electronic device 200 may identify lower right as a direction corresponding to the fifth event. For example, based on touch detection of a lower left border (e.g., a border corresponding to the fourth side surface 214 when the electronic device 200 is disposed vertically) of the display (e.g., foldable display 230), the electronic device 200 may identify lower left as a direction corresponding to the fifth event. According to an embodiment, the electronic device 200 (e.g., the processor 120) may identify a direction corresponding to the fifth event based on a reference range. The electronic device 200 may identify at least one touch position of the fifth event based on identifying the fifth event corresponding to touch detection of the border of the display (e.g., foldable display 230). The at least one touch position may include upper, lower, left, right, upper left, lower left, upper right, and lower right. The electronic device 200 may identify at least one touch range corresponding to the at least one touch position. The at least one touch range may include a touch range corresponding to the upper side, a touch range corresponding to the lower side, a touch range corresponding to the left, a touch range corresponding to the right, a touch range corresponding to the upper left, a touch range corresponding to the lower left, a touch range corresponding to the upper right, and a touch range corresponding to the lower right. The electronic device 200 may compare the at least one touch range with at least one reference range. The at least one reference range may include a reference range corresponding to the upper side, a reference range corresponding to the lower side, a reference range corresponding to the left, a reference range corresponding to the right, a reference range corresponding to the upper left, a reference range corresponding to the lower left, a reference range corresponding to the upper right, and a reference range corresponding to the lower right. Each reference range may be the same, different, or only partially the same. The electronic device 200 may identify a direction corresponding to the fifth event by comparing the at least one touch range with the at least one reference range. For example, the electronic device 200 may identify the upper side as a direction corresponding to the fifth event based on a touch range corresponding to the upper side being greater than or equal to a reference range corresponding to the upper side. For example, the electronic device 200 may identify the lower side as a direction corresponding to the fifth event based on a touch range corresponding to the lower side being greater than or equal to a reference range corresponding to the lower side. For example, the electronic device 200 may identify the left as a direction corresponding to the fifth event based on a touch range corresponding to the left being greater than or equal to a reference range corresponding to the left. For example, the electronic device 200 may identify the right as a direction corresponding to the fifth event based on a touch range corresponding to the right being greater than or equal to a reference range corresponding to the right. For example, the electronic device 200 may identify the upper left as a direction corresponding to the fifth event based on a touch range corresponding to the upper side being greater than or equal to a reference range corresponding to the upper side and a touch range corresponding to the left being greater than or equal to a reference range corresponding to the left. For example, the electronic device 200 may identify the upper right as a direction corresponding to the fifth event based on a touch range corresponding to the upper side being greater than or equal to a reference range corresponding to the upper side and a touch range corresponding to the right being greater than or equal to a reference range corresponding to the right. For example, the electronic device 200 may identify the lower left as a direction corresponding to the fifth event based on a touch range corresponding to the lower side being greater than or equal to a reference range corresponding to the lower side and a touch range corresponding to the left being greater than or equal to a reference range corresponding to the left. For example, the electronic device 200 may identify the lower right as a direction corresponding to the fifth event based on a touch range corresponding to the lower side being greater than or equal to a reference range corresponding to the lower side and a touch range corresponding to the right being greater than or equal to a reference range corresponding to the right. For example, the electronic device 200 may identify the upper left as a direction corresponding to the fifth event based on a touch range corresponding to the upper left being greater than or equal to a reference range corresponding to the upper left. For example, the electronic device 200 may identify the upper right as a direction corresponding to the fifth event based on a touch range corresponding to the upper right being greater than or equal to a reference range corresponding to the upper right. For example, the electronic device 200 may identify the lower left as a direction corresponding to the fifth event based on a touch range corresponding to the lower left being greater than or equal to a reference range corresponding to the lower left. For example, the electronic device 200 may identify the lower right as a direction corresponding to the fifth event based on a touch range corresponding to the lower right being greater than or equal to a reference range corresponding to the lower right.

In operation 1105, according to an embodiment, the electronic device 200 (e.g., the processor 120) may display at least one icon corresponding to at least one port among the plurality of ports 601; 602; 603; 604; 605; 606; 607; 608; 611; 612; 613 of the electronic device 200 based on a direction corresponding to the fifth event. The electronic device 200 may display at least one icon corresponding to the camera 609 based on the direction corresponding to the fifth event. For example, as in FIG. 15 described below, the electronic device 200 may display at least one icon 621; 622; 623; 624; 625; 626; 641; 642; 643; 644; 645; 646; 663; 664; 666 corresponding to at least one port 601; 602; 603; 604; 605; 606 corresponding to the upper side among the plurality of ports 601; 602; 603; 604; 605; 606; 607; 608; 611; 612; 613 based on identifying the upper side as the direction corresponding to the fifth event. For example, as in FIG. 14 described below, the electronic device 200 may display at least one icon 621; 622; 623; 624; 625; 626; 627; 628; 631; 632; 633; 641; 642; 643; 644; 645; 646; 647; 648; 651; 652; 653; 663; 664; 666 corresponding to at least one port 601; 602; 603; 604; 605; 606; 607; 608; 611; 612; 613 corresponding to the upper side and lower side among the plurality of ports 601; 602; 603; 604; 605; 606; 607; 608; 611; 612; 613 based on identifying the upper side and lower side as directions corresponding to the fifth event. For example, as in FIG. 13 described below, the electronic device 200 may display at least one icon 629; 649; 669 corresponding to the camera 609 based on identifying the left as the direction corresponding to the fifth event. The electronic device 200 may not display an icon corresponding to a port based on there being no port corresponding to the left identified as the direction corresponding to the fifth event.

FIG. 12 is a flowchart illustrating an operation method of an electronic device, according to an embodiment of the disclosure. FIG. 12 may be described with reference to the above-described embodiment.

At least some of the operations of FIG. 12 may be omitted. The operation order of the operations of FIG. 12 may be changed. Operations other than the operations of FIG. 12 may be performed before, while, or after performing the operations of FIG. 12.

Referring to FIG. 12, in operation 1201, according to an embodiment, the electronic device 200 (e.g., the processor 120) may identify a sixth event related to connection of a port 601; 602; 603; 604; 605; 606; 607; 608; 611; 612; 613. The electronic device 200 may identify the sixth event corresponding to a connection state (e.g., connected or disconnected) of at least one port 601; 602; 603; 604; 605; 606; 607; 608; 611; 612; 613 as the at least one event of operation 501 of FIG. 5.

In operation 1205, according to an embodiment, the electronic device 200 (e.g., the processor 120) may display at least one icon corresponding to at least one port 601; 602; 603; 604; 605; 606; 607; 608; 611; 612; 613 based on a connection state (e.g., connected or disconnected) of the at least one port 601; 602; 603; 604; 605; 606; 607; 608; 611; 612; 613. For example, the electronic device 200 may display at least one icon (e.g., 643; 644; 646 of FIG. 6) indicating that an external device is connected to at least one port (e.g., 603; 604; 606 of FIG. 6). For example, the electronic device 200 may display at least one icon (e.g., 663; 664; 666 of FIG. 6) indicating information related to an external device connected to at least one port (e.g., 603; 604; 606 of FIG. 6). For example, the electronic device 200 may display at least one icon (e.g., 641; 642; 645; 647; 648; 651; 652; 653 of FIG. 6) indicating that an external device is not connected to at least one port (e.g., 601; 602; 605; 607; 608; 611; 612; 613 of FIG. 6).

FIG. 13 is a view illustrating an operation of an electronic device, according to an embodiment of the disclosure.

FIG. 14 is a view illustrating operations of an electronic device according to an embodiment of the disclosure.

FIG. 15 is a view illustrating operations of an electronic device according to an embodiment of the disclosure.

FIG. 13 illustrates a case where the left side of the electronic device 200 is selected based on at least one event when the electronic device 200 is disposed horizontally.

FIG. 14 illustrates a case where the upper side and lower side of the electronic device 200 are selected based on at least one event when the electronic device 200 is disposed horizontally.

FIG. 15 illustrates a case where the upper side of the electronic device 200 is selected based on at least one event when the electronic device 200 is disposed horizontally.

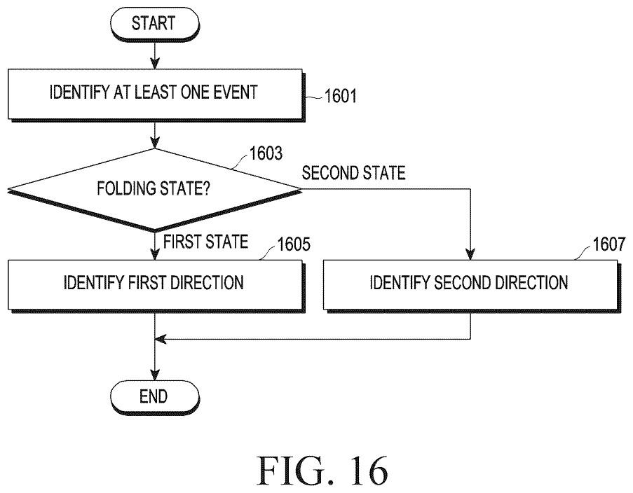

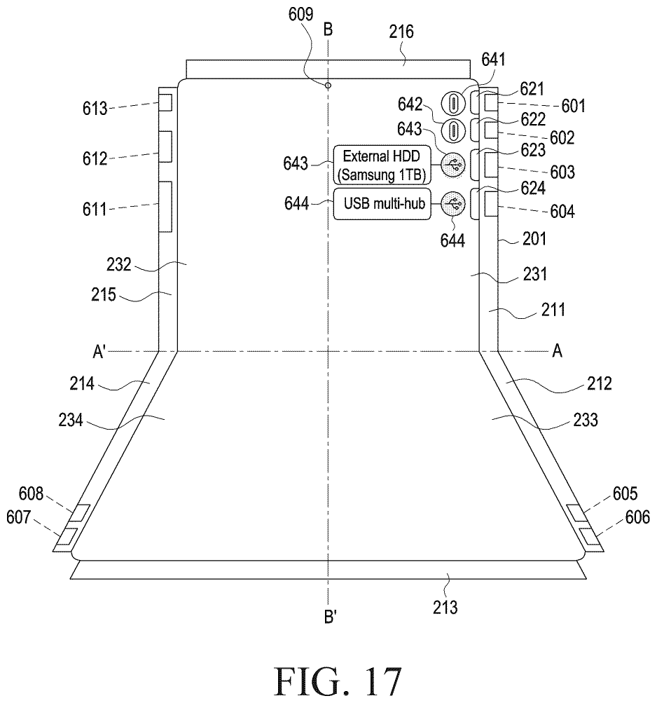

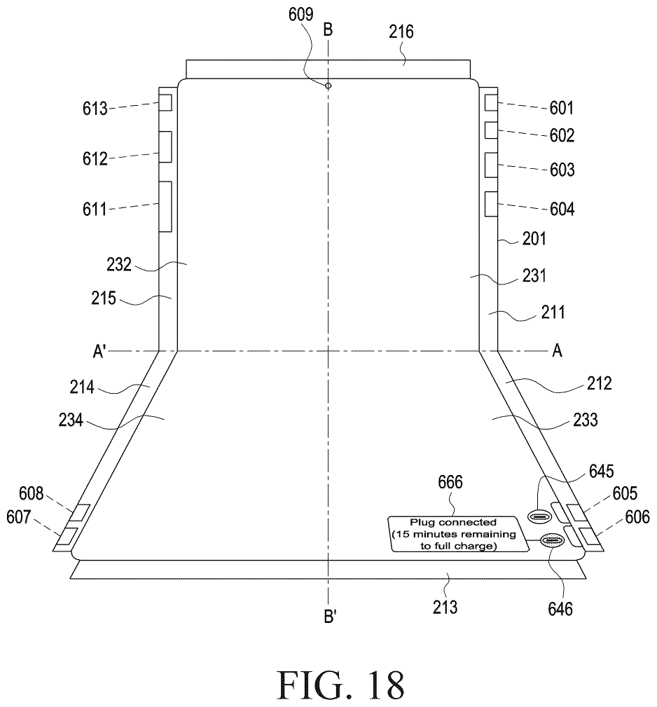

FIG. 16 is a flowchart illustrating an operation method of an electronic device, according to an embodiment of the disclosure. FIG. 16 may be described with reference to previously described embodiments, FIGS. 17, 18, and 19. FIG. 17 is a view illustrating an operation of an electronic device, according to an embodiment of the disclosure. FIG. 18 is a view illustrating an operation of an electronic device, according to an embodiment of the disclosure. FIG. 19 is a view illustrating operations of an electronic device according to an embodiment of the disclosure.

Referring to FIG. 16, a process in which the same event is processed differently according to a folding state of the electronic device 200 may be understood.

At least some of the operations of FIG. 16 may be omitted. The operation order of the operations of FIG. 16 may be changed. Operations other than the operations of FIG. 16 may be performed before, while, or after performing the operations of FIG. 16.

Referring to FIG. 16, in operation 1601, according to an embodiment, the electronic device 200 (e.g., the processor 120) may identify at least one event. The at least one event may be at least one of a first event, a second event, a third event, a fourth event, a fifth event, or a sixth event. The first event may correspond to a shortcut key input. The second event may correspond to a gesture input. The third event may correspond to tilt detection. The fourth event may correspond to touch detection of the side surface (e.g., side surfaces 211, 215, 216 of the first housing 201 or side surfaces 212, 213, 214 of the second housing 202) of the housing. The fifth event may correspond to touch detection of a border of the display (e.g., foldable display 230). The sixth event may correspond to a connection state (e.g., connected or disconnected) of at least one port 601; 602; 603; 604; 605; 606; 607; 608; 611; 612; 613. Operation 1601 may be the same as or similar to operation 501 of FIG. 5. Among the description of operation 1601, portions that overlap the description of operation 501 of FIG. 5 are omitted.

In operation 1603, according to an embodiment, the electronic device 200 (e.g., the processor 120) may identify a folding state of the electronic device 200. For example, the folding state of the electronic device 200 may include an unfolded state, a folded state, or a partially unfolded (or partially folded) intermediate state of the electronic device 200. Operation 1603 may be performed after operation 1601 is performed, or may be performed before performing operation 1601.

In operation 1605, according to an embodiment, the electronic device 200 (e.g., the processor 120) may identify a direction (e.g., direction or position of a touched border) corresponding to at least one event as a first direction based on the folding state of the electronic device 200 being a first state (e.g., unfolded state). For example, a direction corresponding to at least one event may include a position corresponding to at least one event. In operation 1605, the first direction may be determined based on at least one event. A method in which the direction is determined in operation 1605 may be understood with reference to the embodiments of FIGS. 9, 10, and 11.

In operation 1607, according to an embodiment, the electronic device 200 (e.g., the processor 120) may identify a direction corresponding to at least one event as a second direction based on the folding state of the electronic device 200 being a second state (e.g., intermediate state). In operation 1607, the second direction may be determined based on at least one event and the second state (e.g., intermediate state). The second direction of operation 1607 may be the same as or different from the first direction of operation 1605. A method in which the direction is determined in operation 1607 may be understood with reference to the embodiments of FIGS. 9, 10, and 11.

Operations 1605 and 1607 are described as follows. According to an embodiment, when the electronic device is disposed horizontally in an unfolded state of the electronic device 200, the electronic device 200 may identify a direction corresponding to at least one event based on at least one event. According to an embodiment, when the electronic device 200 is disposed horizontally in an intermediate state of the electronic device 200, the electronic device 200 may identify a direction corresponding to at least one event based on the folding state and at least one event. According to an embodiment, when the electronic device 200 is disposed vertically in an unfolded state of the electronic device 200, the electronic device 200 may identify a direction corresponding to at least one event based on at least one event. According to an embodiment, when the electronic device 200 is disposed vertically in an intermediate state of the electronic device 200, the electronic device 200 may identify a direction corresponding to at least one event based on the folding state and at least one event. For example, when the electronic device 200 is disposed vertically and the folding state of the electronic device 200 is an intermediate state, when a touch of the first side surface 211 is detected (or when a touch of a border (e.g., upper right border) of the display (e.g., foldable display 230) corresponding to the first side surface 211 is detected), as in FIG. 17, an icon corresponding to a port (e.g., 601, 602, 603, 604) disposed on the upper right side surface may be displayed and, when a touch of the second side surface 212 is detected (or when a touch of a border (e.g., lower right border) of the display (e.g., foldable display 230) corresponding to the second side surface 212 is detected), as in FIG. 18, an icon corresponding to a port (e.g., 605, 606) disposed on the lower right side surface may be displayed. For example, when the electronic device 200 is disposed vertically and the folding state of the electronic device 200 is an unfolded state, as in FIG. 19, when a touch of the first side surface 211 (or a touch of a border (e.g., upper right border) of the display (e.g., foldable display 230) corresponding to the first side surface 211) is detected or a touch of the second side surface 212 (or a touch of a border (e.g., lower right border) of the display (e.g., foldable display 230) corresponding to the second side surface 212) is detected, an icon corresponding to a port (e.g., 601, 602, 603, 604, 605, 606) disposed on the right side surface may be displayed. Other cases may be similarly understood.

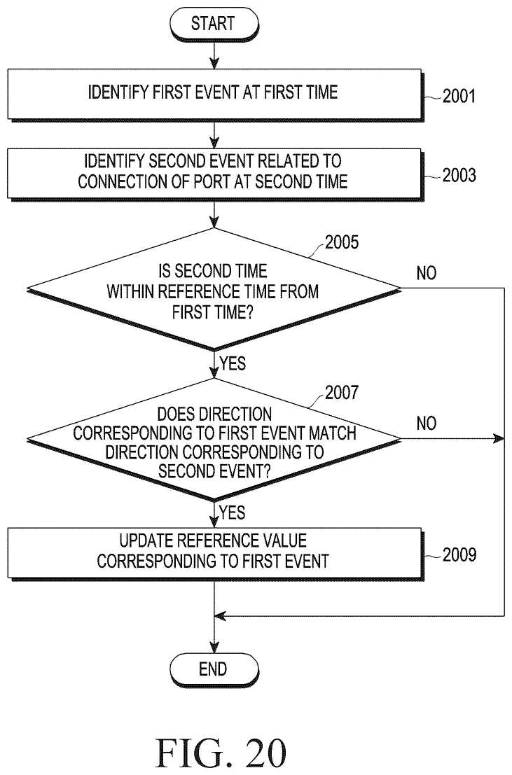

FIG. 20 is a flowchart illustrating an operation method of an electronic device, according to an embodiment of the disclosure. FIG. 20 may be described with reference to the above-described embodiment.

Referring to FIG. 20, an update of reference values (e.g., reference angle of FIG. 9, or reference range of FIG. 10 or FIG. 11) may be understood.

At least some of the operations of FIG. 20 may be omitted. The operation order of the operations of FIG. 20 may be changed. Operations other than the operations of FIG. 20 may be performed before, while, or after performing the operations of FIG. 20.

Referring to FIG. 20, in operation 2001, according to an embodiment, the electronic device 200 (e.g., the processor 120) may identify a first event at a first time. The first event of operation 2001 may be one of an event corresponding to tilt detection of FIG. 9, an event corresponding to touch detection of the side surface 211, 212, 213, 214, 215, 216 of FIG. 10, or an event corresponding to touch detection of a border of the display (e.g., foldable display 230).

In operation 2003, according to an embodiment, the electronic device 200 (e.g., the processor 120) may identify a second event related to connection of a port at a second time. The second event of operation 2003 may be an event indicating that an external device is connected to at least one port (e.g., 603; 604; 606) among the plurality of ports 601; 602; 603; 604; 605; 606; 607; 608; 611; 612; 613 of the electronic device 200.

In operation 2005, according to an embodiment, the electronic device 200 (e.g., the processor 120) may identify whether the second time of operation 2003 is within a reference time from the first time of operation 2001. The electronic device 200 may perform operation 2007 based on the second event being identified within the reference time from a time when the first event is identified.

In operation 2007, according to an embodiment, the electronic device 200 (e.g., the processor 120) may identify whether a direction corresponding to the first event of operation 2001 matches a direction corresponding to the second event of operation 2003. According to an embodiment, “direction” may include “position”. The direction corresponding to the first event of operation 2001 may be understood with reference to the embodiment of identifying a direction corresponding to an event in FIGS. 9, 10, and 11. The direction corresponding to the second event of operation 2003 may be a direction of a port (e.g., 603; 604; 606) connected within the reference time from the time when the first event of operation 2001 is identified. For example, when the electronic device 200 is disposed vertically, if touch detection of a lower right side surface (e.g., second side surface 212) is identified at the first time, and connection of an external device to a port (e.g., sixth port 606) disposed on the lower right side surface (e.g., second side surface 212) is identified within the reference time from the first time, the electronic device 200 may identify a match of the directions of operation 2007. For example, when the electronic device 200 is disposed vertically, if touch detection of a lower right side surface (e.g., second side surface 212) is identified at the first time, and connection of an external device to a port (e.g., seventh port 607) disposed on the lower left side surface (e.g., fourth side surface 214) is identified within the reference time from the first time, the electronic device 200 may identify that the directions of operation 2007 do not match.

In operation 2009, according to an embodiment, the electronic device 200 (e.g., the processor 120) may update a reference value corresponding to the first event of operation 2001 based on identifying the match of the directions of operation 2007. For example, when the first event of operation 2001 is an event corresponding to tilt detection, the electronic device 200 may update a reference angle related to tilt detection to a tilt angle corresponding to operation 2001. For example, when the first event of operation 2001 is an event corresponding to touch detection of the side surface 211, 212, 213, 214, 215, 216, the electronic device 200 may update a reference range related to touch detection of the side surface 211, 212, 213, 214, 215, 216 to a touch range corresponding to operation 2001. For example, when the first event of operation 2001 is an event corresponding to touch detection of a border of the display (e.g., foldable display 230), the electronic device 200 may update a reference range related to touch detection of the border of the display (e.g., foldable display 230) to a touch range corresponding to operation 2001.

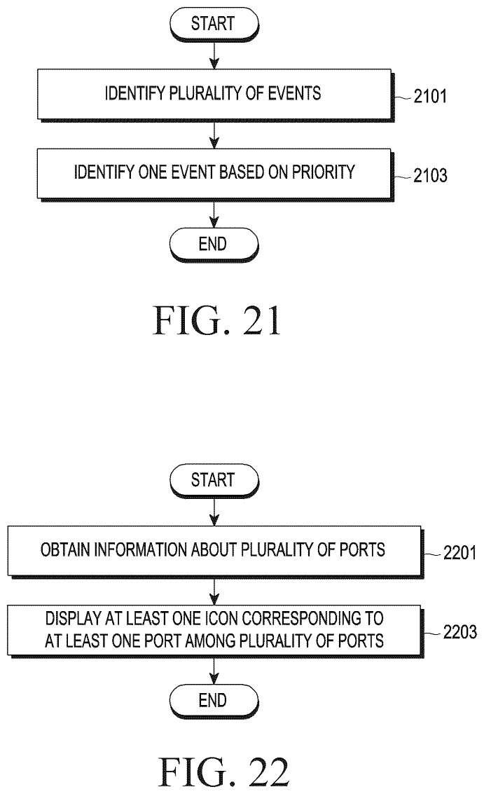

FIG. 21 is a flowchart illustrating an operation method of an electronic device, according to an embodiment of the disclosure. FIG. 21 may be described with reference to the above-described embodiment.

At least some of the operations of FIG. 21 may be omitted. The operation order of the operations of FIG. 21 may be changed. Operations other than the operations of FIG. 21 may be performed before, while, or after performing the operations of FIG. 21.

Referring to FIG. 21, in operation 2101, according to an embodiment, the electronic device 200 (e.g., the processor 120) may identify a plurality of events. The plurality of events may include at least two events among an event corresponding to a shortcut key input, an event corresponding to a gesture input, an event corresponding to tilt detection, an event corresponding to touch detection of the side surface 211, 212, 213, 214, 215, 216, or an event corresponding to touch detection of a border of the display (e.g., foldable display 230). The electronic device 200 may identify the plurality of events simultaneously or may identify the plurality of events within a designated time.

In operation 2103, according to an embodiment, the electronic device 200 (e.g., the processor 120) may identify one event among the plurality of events based on priority. The electronic device 200 may perform a specific operation based on one event selected based on designated priority. For example, when the electronic device 200 identifies a first event and a second event simultaneously or within a designated time, e.g., if the priority of the second event is higher than the priority of the first event, port information (or an icon corresponding to port information) may be displayed based on the second event. An embodiment of displaying port information (or an icon corresponding to port information) may be understood with reference to the previously described embodiments.

FIG. 22 is a flowchart illustrating an operation method of an electronic device, according to an embodiment of the disclosure. FIG. 22 may be described with reference to the above-described embodiment.

At least some of the operations of FIG. 22 may be omitted. The operation order of the operations of FIG. 22 may be changed. Operations other than the operations of FIG. 22 may be performed before, while, or after performing the operations of FIG. 22.

Referring to FIG. 22, in operation 2201, according to an embodiment, the electronic device 200 (e.g., the processor 120) may obtain information about the plurality of ports 601; 602; 603; 604; 605; 606; 607; 608; 611; 612; 613. According to an embodiment, the electronic device 200 may obtain information about the plurality of ports 601; 602; 603; 604; 605; 606; 607; 608; 611; 612; 613 from a server (e.g., server 108 of FIG. 1) through a communication module (e.g., communication module 190). The information may correspond to the plurality of ports 601; 602; 603; 604; 605; 606; 607; 608; 611; 612; 613. For example, information corresponding to the plurality of ports 601; 602; 603; 604; 605; 606; 607; 608; 611; 612; 613 may include a port ID, a port type, a port name, a side surface 211, 212, 213, 214, 215, 216 on which the port is disposed, or a detailed position of the port on the side surface 211, 212, 213, 214, 215, 216 on which the port is disposed. There is no limitation on when the electronic device 200 obtains information from the server (e.g., server 108 of FIG. 1). The electronic device 200 may update information corresponding to the plurality of ports 601; 602; 603; 604; 605; 606; 607; 608; 611; 612; 613 by comparing information obtained from the server (e.g., server 108 of FIG. 1) with information stored in memory (e.g., memory 130). According to an embodiment, the electronic device 200 may obtain (e.g., identify) information about the plurality of ports 601; 602; 603; 604; 605; 606; 607; 608; 611; 612; 613 stored in memory (e.g., memory 130). For example, the electronic device 200 may store information about the plurality of ports 601; 602; 603; 604; 605; 606; 607; 608; 611; 612; 613 obtained from the server (e.g., server 108 of FIG. 1) in memory (e.g., memory 130), or may include memory (e.g., memory 130) storing information about the plurality of ports 601; 602; 603; 604; 605; 606; 607; 608; 611; 612; 613 regardless of the server (e.g., server 108 of FIG. 1). In operation 2203, according to an embodiment, the electronic device 200 (e.g., the processor 120) may display at least one icon corresponding to the at least one port among the plurality of ports 601; 602; 603; 604; 605; 606; 607; 608; 611; 612; 613.

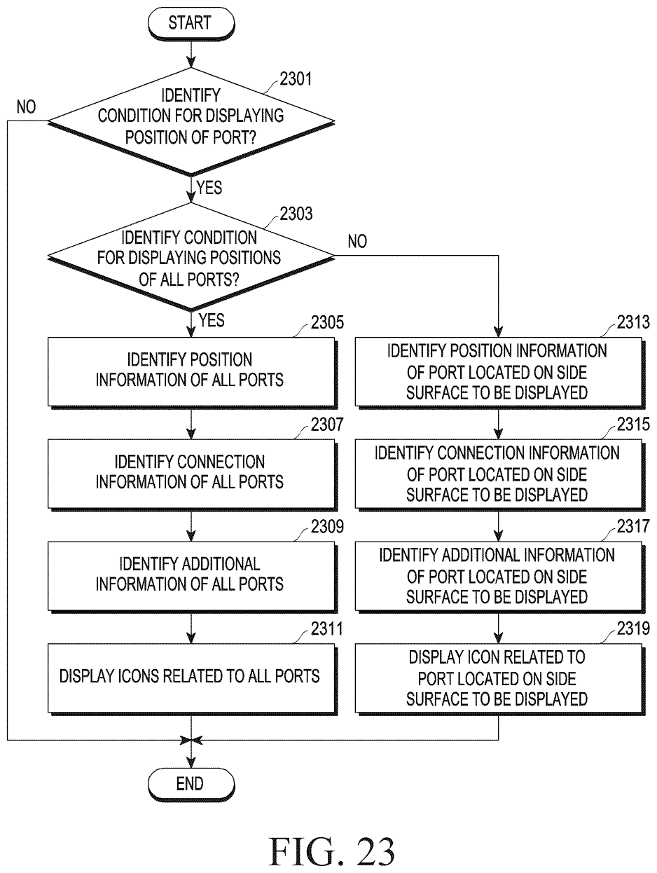

FIG. 23 is a flowchart illustrating an operation method of an electronic device, according to an embodiment of the disclosure. FIG. 23 may be described with reference to the above-described embodiment.

At least some of the operations of FIG. 23 may be omitted. The operation order of the operations of FIG. 23 may be changed. Operations other than the operations of FIG. 23 may be performed before, while, or after performing the operations of FIG. 23.

Referring to FIG. 23, in operation 2301, according to an embodiment, the electronic device 200 (e.g., the processor 120) may identify a condition for displaying a position of a port (e.g., 601; 602; 603; 604; 605; 606; 607; 608; 611; 612; 613) (e.g., occurrence of an event in FIGS. 7, 8, 9, 10, and/or 11).

In operation 2303, according to an embodiment, the electronic device 200 (e.g., the processor 120) may perform operations 2305, 2307, 2309, and 2311 based on identifying that the condition identified in operation 2301 is a condition for displaying positions of all ports (e.g., 601; 602; 603; 604; 605; 606; 607; 608; 611; 612; 613) (e.g., occurrence of an event in FIGS. 7 and/or 8). In operation 2303, according to an embodiment, the electronic device 200 (e.g., the processor 120) may perform operations 2313, 2315, 2317, and 2319 based on identifying that the condition identified in operation 2301 is not a condition for displaying positions of all ports (e.g., 601; 602; 603; 604; 605; 606; 607; 608; 611; 612; 613) (e.g., identifying occurrence of an event in FIGS. 9, 10, and/or 11).

In operation 2305, according to an embodiment, the electronic device 200 (e.g., the processor 120) may identify position information of all ports (e.g., 601; 602; 603; 604; 605; 606; 607; 608; 611; 612; 613). For example, the electronic device 200 may identify position information of all ports stored in memory (e.g., memory 130). For example, the electronic device 200 may obtain position information of all ports from a server (e.g., server 108).

In operation 2307, according to an embodiment, the electronic device 200 (e.g., the processor 120) may identify connection information (e.g., connected or disconnected) of all ports (e.g., 601; 602; 603; 604; 605; 606; 607; 608; 611; 612; 613).

In operation 2309, according to an embodiment, the electronic device 200 (e.g., the processor 120) may identify additional information of all ports (e.g., 601; 602; 603; 604; 605; 606; 607; 608; 611; 612; 613). For example, the electronic device 200 may identify additional information of all ports stored in memory (e.g., memory 130). For example, the electronic device 200 may obtain additional information of all ports from a server (e.g., server 108).

In operation 2311, according to an embodiment, the electronic device 200 (e.g., the processor 120) may display icons (e.g., icons corresponding to position information, connection information, and/or additional information) related to all ports (e.g., 601; 602; 603; 604; 605; 606; 607; 608; 611; 612; 613).

In operation 2313, according to an embodiment, the electronic device 200 (e.g., the processor 120) may identify position information of a port (e.g., 601; 602; 603; 604; 605; 606; 607; 608; 611; 612; 613) located on a side surface to be displayed (e.g., a side surface in a direction (and/or position) corresponding to an event). For example, the electronic device 200 may identify position information of a port located on a side surface to be displayed (e.g., a side surface in a direction (and/or position) corresponding to an event) stored in memory (e.g., memory 130). For example, the electronic device 200 may obtain position information of a port located on a side surface to be displayed (e.g., a side surface in a direction (and/or position) corresponding to an event) from a server (e.g., server 108).

In operation 2315, according to an embodiment, the electronic device 200 (e.g., the processor 120) may identify connection information (e.g., connected or disconnected) of a port (e.g., 601; 602; 603; 604; 605; 606; 607; 608; 611; 612; 613) located on a side surface to be displayed (e.g., a side surface in a direction (and/or position) corresponding to an event).

In operation 2317, according to an embodiment, the electronic device 200 (e.g., the processor 120) may identify additional information of a port (e.g., 601; 602; 603; 604; 605; 606; 607; 608; 611; 612; 613) located on a side surface to be displayed (e.g., a side surface in a direction (and/or position) corresponding to an event). For example, the electronic device 200 may identify additional information of a port located on a side surface to be displayed (e.g., a side surface in a direction (and/or position) corresponding to an event) stored in memory (e.g., memory 130). For example, the electronic device 200 may obtain additional information of a port located on a side surface to be displayed (e.g., a side surface in a direction (and/or position) corresponding to an event) from a server (e.g., server 108).

In operation 2319, according to an embodiment, the electronic device 200 (e.g., the processor 120) may display an icon (e.g., an icon corresponding to position information, connection information, and/or additional information) related to a port (e.g., 601; 602; 603; 604; 605; 606; 607; 608; 611; 612; 613) located on a side surface to be displayed (e.g., a side surface in a direction (and/or position) corresponding to an event).

FIG. 24 is a view illustrating an electronic device, according to an embodiment of the disclosure.

As described above, according to an embodiment, the electronic device 2400 of FIG. 24 may be a non-folding device. The remaining embodiments except for the embodiments related to folding of the electronic device 200 of FIG. 2 may be applied to the electronic device 2400 of FIG. 24. For example, the embodiments of FIGS. 5, 6, 7, 8, 9, 10, 11, 12, 13, 14, 15, 20, 21, 22, and 23 may also be applied to the electronic device 2400 of FIG. 24.

In an embodiment, referring to FIG. 24, the electronic device 2400 may include a housing 2401; 2402 and a display module 160 (e.g., a display 2430) disposed in a space formed by the housing 2401; 2402. The housing 2401; 2402 may include a first area 2431 and a second area 2432. The display 2430 may include a plurality of areas 2431; 2432; 2433; 2434. A surface on which the display 2430 is disposed (or a surface on which the display 2430 is visible from outside of the electronic device 2400) may be defined as a front surface of the electronic device 2400. A surface opposite to the front surface may be defined as a rear surface 2421; 2422; 2423; 2424 of the electronic device 2400. A surface surrounding a space between the front surface and the rear surface 2421; 2422; 2423; 2424 may be defined as a side surface 2411; 2412; 2413; 2414; 2415; 2416 of the electronic device 2400.

According to an embodiment, at least a portion of the housing 2401; 2402 may be formed of a metal material or a non-metal material having a stiffness of a selected size to support the display 2430. At least a portion formed of metal may provide a ground plane of the electronic device 2400 and may be electrically connected with a ground line formed on the printed circuit board.

According to an embodiment, one or more components or sensors may be disposed or visually exposed on the rear surface 2421; 2422; 2423; 2424 of the electronic device 2400. For example, a sensor exposed through the rear surface 2421; 2422; 2423; 2424 may include a proximity sensor or a rear camera.

According to an embodiment, the display 2430 may be disposed on a space formed by the housing 2401; 2402. For example, the display 2430 may be seated on a recess formed by the housing 2401; 2402 and may constitute most of the front surface of the electronic device 2400.

According to an embodiment, the front surface of the electronic device 2400 may include the display 2430 and a partial area of the housing 2401; 2402 adjacent to the display 2430.

According to an embodiment, the display 2430 may include four areas (e.g., a first area 2431, a second area 2432, a third area 2433, and a fourth area 2434) based on a first axis A-A′ and a second axis B-B'. According to rotation of the electronic device 2400, positions of the plurality of areas 2431; 2432; 2433; 2434 of the display 2430, such as left, right, upper, lower, upper left, lower left, upper right, and lower right, may be defined differently.

Meanwhile, the area division of the display 2430 illustrated in FIG. 24 is exemplary, and the display 2430 may be divided into a plurality (e.g., 6 or more or 4 or less) of areas according to structure or function. Further, the plurality of areas 2431; 2432; 2433; 2434 of the display 2430 are logically distinguished areas for convenience of description and may not be hardware-separated areas.

According to an embodiment, the side surface 2411; 2412; 2413; 2414; 2415; 2416 of the electronic device 2400 may include a first side surface 2411, a second side surface 2412, a third side surface 2413, a fourth side surface 2414, a fifth side surface 2415, and a sixth side surface 2416. The first side surface 2411 and the second side surface 2412 may form one side surface. The first side surface 2411 and the second side surface 2412 may be distinguished based on the first axis A-A′. The fourth side surface 2414 and the fifth side surface 2415 may form one side surface. The fourth side surface 2414 and the fifth side surface 2415 may be distinguished based on the first axis A-A′. The third side surface 2413 may be one undivided side surface. The sixth side surface 2416 may be one undivided side surface.

The electronic device 2400 of FIG. 24 may be understood the same as the electronic device 200 of FIG. 2, except that it does not fold. For example, the electronic device 2400 of FIG. 24 may display at least one icon corresponding to at least one port among the plurality of ports 601; 602; 603; 604; 605; 606; 607; 608; 611; 612; 613 based on at least one event (e.g., at least one event among an event corresponding to a shortcut key input, an event corresponding to a gesture input, an event corresponding to tilt detection, an event corresponding to touch detection of the side surface 2411, 2412, 2413, 2414, 2415, 2416, or an event corresponding to touch detection of a border of the display (e.g., display 2430)). Therefore, overlapping descriptions are omitted.

It may be understood by one of ordinary skill in the art that embodiments described herein may be applied interchangeably within the applicable scope. For example, those skilled in the art may understand that at least some operations of an embodiment described in this specification may be omitted and applied, or at least some operations of one embodiment and at least some operations of another embodiment may be connected and applied.

According to an embodiment, an electronic device 101; 200 may include a first housing 201 including a first surface and a second surface facing in a direction opposite to a direction in which the first surface faces, a second housing 202 including a third surface and a fourth surface facing in a direction opposite to a direction in which the third surface faces, a hinge 400 disposed between the first housing 201 and the second housing 202 and configured to change a folding state of the electronic device 101; 200, a foldable display 160; 230 disposed on the first surface and the third surface, a plurality of ports 601; 602; 603; 604; 605; 606; 607; 608; 611; 612; 613 disposed on a side surface of the first housing 201 or a side surface of the second housing 202, and a processor 120. The processor 120 may be configured to identify the folding state. The processor 120 may be configured to identify at least one event. The processor 120 may be configured to display, based on the folding state and the at least one event, at least one icon corresponding to at least one port 601; 602; 603; 604; 605; 606; 607; 608; 611; 612; 613 among the plurality of ports 601; 602; 603; 604; 605; 606; 607; 608; 611; 612; 613 on at least one area 231; 232; 233; 234; 235 of the foldable display 160; 230. The at least one area 231; 232; 233; 234; 235 may correspond to a position of the at least one port 601; 602; 603; 604; 605; 606; 607; 608; 611; 612; 613 among the plurality of ports 601; 602; 603; 604; 605; 606; 607; 608; 611; 612; 613.

According to an embodiment, the processor 120 may be configured to control the foldable display 160; 230 to display all of a plurality of icons corresponding to the plurality of ports 601; 602; 603; 604; 605; 606; 607; 608; 611; 612; 613 based on identifying at least one of a first event corresponding to a shortcut key input or a second event corresponding to a gesture input.

According to an embodiment, the processor 120 may be configured to identify a direction corresponding to at least one of a third event corresponding to tilt detection, a fourth event corresponding to touch detection of the side surface of the first housing 201 or the side surface of the second housing 202, or a fifth event corresponding to touch detection of a border of the foldable display 160; 230, based on identifying at least one of the third event, the fourth event, or the fifth event. The processor 120 may be configured to control the foldable display 160; 230 to display at least one icon corresponding to at least one port 601; 602; 603; 604; 605; 606; 607; 608; 611; 612; 613 corresponding to the direction among the plurality of ports 601; 602; 603; 604; 605; 606; 607; 608; 611; 612; 613.

According to an embodiment, the processor 120 may be configured to identify a first direction as the direction based on the folding state being a first state. The first direction may correspond to the at least one event. The processor 120 may be configured to identify a second direction as the direction based on the folding state being a second state. The second direction may correspond to the at least one event and the second state.

According to an embodiment, the processor 120 may be configured to identify at least one tilt angle of the electronic device 101; 200 corresponding to the third event based on identifying the third event. The processor 120 may be configured to identify the direction by comparing the at least one tilt angle with at least one reference angle.

According to an embodiment, the processor 120 may be configured to identify at least one first touch position corresponding to the fourth event based on identifying the fourth event. The processor 120 may be configured to identify the direction based on the at least one first touch position.

According to an embodiment, the processor 120 may be configured to identify at least one first touch range corresponding to the at least one first touch position. The processor 120 may be configured to identify the direction by comparing the at least one first touch range with at least one first reference range.

According to an embodiment, the processor 120 may be configured to identify at least one second touch position corresponding to the fifth event based on identifying the fifth event. The processor 120 may be configured to identify the direction based on the at least one second touch position.

According to an embodiment, the processor 120 may be configured to identify at least one second touch range corresponding to the at least one second touch position. The processor 120 may be configured to identify the direction by comparing the at least one second touch range with at least one second reference range.

According to an embodiment, the processor 120 may be configured to identify a sixth event related to connection of the at least one port 601; 602; 603; 604; 605; 606; 607; 608; 611; 612; 613. The processor 120 may be configured to display the at least one icon based on the sixth event.

According to an embodiment, the processor 120 may be configured to update at least one reference value corresponding to the at least one event based on the at least one event and the sixth event. The processor 120 may be configured to display the at least one icon based on the updated at least one reference value.

According to an embodiment, the processor 120 may be configured to update the at least one reference value corresponding to the at least one event based on the sixth event occurring within a reference time from a time when the at least one event occurs and a direction corresponding to the at least one event matching a direction corresponding to the sixth event.

According to an embodiment, the processor 120 may be configured to identify one event among the at least one event based on a designated priority. The processor 120 may be configured to display the at least one icon corresponding to the at least one port 601; 602; 603; 604; 605; 606; 607; 608; 611; 612; 613 based on the one event identified based on the designated priority.

According to an embodiment, the electronic device 101; 200 may include a communication module 190. The processor 120 may be configured to obtain information about the plurality of ports 601; 602; 603; 604; 605; 606; 607; 608; 611; 612; 613 from a server 108 through the communication module 190. The information may correspond to the plurality of ports 601; 602; 603; 604; 605; 606; 607; 608; 611; 612; 613.

According to an embodiment, a method of operating an electronic device 101; 200 may include identifying a folding state of the electronic device 101; 200. The method may include identifying at least one event. The method may include displaying, based on the folding state and the at least one event, at least one icon corresponding to at least one port 601; 602; 603; 604; 605; 606; 607; 608; 611; 612; 613 among a plurality of ports 601; 602; 603; 604; 605; 606; 607; 608; 611; 612; 613 disposed on a side surface of a housing 201; 202 of the electronic device 101; 200 on at least one area 231; 232; 233; 234; 235 of a foldable display 160; 230 of the electronic device 101; 200. The at least one area 231; 232; 233; 234; 235 may correspond to a position of the at least one port 601; 602; 603; 604; 605; 606; 607; 608; 611; 612; 613 among the plurality of ports 601; 602; 603; 604; 605; 606; 607; 608; 611; 612; 613.

According to an embodiment, displaying the at least one icon may include displaying all of a plurality of icons corresponding to the plurality of ports 601; 602; 603; 604; 605; 606; 607; 608; 611; 612; 613 based on identifying at least one of a first event corresponding to a shortcut key input or a second event corresponding to a gesture input.

According to an embodiment, displaying the at least one icon may include identifying a direction corresponding to the at least one of the third event, the fourth event, or the fifth event based on identifying at least one of a third event corresponding to tilt detection, a fourth event corresponding to touch detection of the side surface of the first housing 201 or the side surface of the second housing 202, or a fifth event corresponding to touch detection of a border of the foldable display 160; 230. Displaying the at least one icon may include displaying at least one icon corresponding to at least one port 601; 602; 603; 604; 605; 606; 607; 608; 611; 612; 613 corresponding to the direction among the plurality of ports 601; 602; 603; 604; 605; 606; 607; 608; 611; 612; 613.

According to an embodiment, identifying the direction may include identifying a first direction as the direction based on the folding state being a first state. The first direction may correspond to the at least one event. Identifying the direction may include identifying a second direction as the direction based on the folding state being a second state. The second direction may correspond to the at least one event and the second state.

According to an embodiment, identifying the direction may include identifying at least one tilt angle of the electronic device 101; 200 corresponding to the third event based on identifying the third event. Identifying the direction may include identifying the direction by comparing the at least one tilt angle with at least one reference angle.

According to an embodiment, identifying the direction may include identifying at least one first touch position corresponding to the fourth event based on identifying the fourth event. Identifying the direction may include identifying the direction based on the at least one first touch position.

According to an embodiment, identifying the direction may include identifying at least one first touch range corresponding to the at least one first touch position. Identifying the direction may include identifying the direction by comparing the at least one first touch range with at least one first reference range.

According to an embodiment, identifying the direction may include identifying at least one second touch position corresponding to the fifth event based on identifying the fifth event. Identifying the direction may include identifying the direction based on the at least one second touch position.

According to an embodiment, identifying the direction may include identifying at least one second touch range corresponding to the at least one second touch position. Identifying the direction may include identifying the direction by comparing the at least one second touch range with at least one second reference range.

According to an embodiment, displaying the at least one icon may include identifying a sixth event related to connection of the at least one port 601; 602; 603; 604; 605; 606; 607; 608; 611; 612; 613. Displaying the at least one icon may include displaying the at least one icon based on the sixth event.

According to an embodiment, displaying the at least one icon may include updating at least one reference value corresponding to the at least one event based on the at least one event and the sixth event. Displaying the at least one icon may include displaying the at least one icon based on the updated at least one reference value.

According to an embodiment, updating the at least one reference value may include updating the at least one reference value corresponding to the at least one event based on the sixth event occurring within a reference time from a time when the at least one event occurs and a direction corresponding to the at least one event matching a direction corresponding to the sixth event.

According to an embodiment, displaying the at least one icon may include identifying one event among the at least one event based on a designated priority. Displaying the at least one icon may include displaying the at least one icon corresponding to the at least one port 601; 602; 603; 604; 605; 606; 607; 608; 611; 612; 613 based on the one event identified based on the designated priority.

According to an embodiment, the electronic device 101; 200 may include a communication module 190. The method may include obtaining information about the plurality of ports 601; 602; 603; 604; 605; 606; 607; 608; 611; 612; 613 from a server 108 through the communication module 190. The information may correspond to the plurality of ports 601; 602; 603; 604; 605; 606; 607; 608; 611; 612; 613.

According to an embodiment, in a computer readable recording medium storing instructions configured to perform at least one operation by a processor 120 of an electronic device 101; 200, the at least one operation may include identifying a folding state of the electronic device 101; 200. The at least one operation may include identifying at least one event. The at least one operation may include displaying, based on the folding state and the at least one event, at least one icon corresponding to at least one port 601; 602; 603; 604; 605; 606; 607; 608; 611; 612; 613 among a plurality of ports 601; 602; 603; 604; 605; 606; 607; 608; 611; 612; 613 disposed on a side surface of a housing 201; 202 of the electronic device 101; 200 on at least one area 231; 232; 233; 234; 235 of a foldable display 160; 230 of the electronic device 101; 200. The at least one area 231; 232; 233; 234; 235 may correspond to a position of the at least one port 601; 602; 603; 604; 605; 606; 607; 608; 611; 612; 613 among the plurality of ports 601; 602; 603; 604; 605; 606; 607; 608; 611; 612; 613.

According to an embodiment, displaying the at least one icon may include displaying all of a plurality of icons corresponding to the plurality of ports 601; 602; 603; 604; 605; 606; 607; 608; 611; 612; 613 based on identifying at least one of a first event corresponding to a shortcut key input or a second event corresponding to a gesture input.

According to an embodiment, displaying the at least one icon may include identifying a direction corresponding to the at least one of the third event, the fourth event, or the fifth event based on identifying at least one of a third event corresponding to tilt detection, a fourth event corresponding to touch detection of the side surface of the first housing 201 or the side surface of the second housing 202, or a fifth event corresponding to touch detection of a border of the foldable display 160; 230. Displaying the at least one icon may include displaying at least one icon corresponding to at least one port 601; 602; 603; 604; 605; 606; 607; 608; 611; 612; 613 corresponding to the direction among the plurality of ports 601; 602; 603; 604; 605; 606; 607; 608; 611; 612; 613.

According to an embodiment, identifying the direction may include identifying a first direction as the direction based on the folding state being a first state. The first direction may correspond to the at least one event. Identifying the direction may include identifying a second direction as the direction based on the folding state being a second state. The second direction may correspond to the at least one event and the second state.

According to an embodiment, identifying the direction may include identifying at least one tilt angle of the electronic device 101; 200 corresponding to the third event based on identifying the third event. Identifying the direction may include identifying the direction by comparing the at least one tilt angle with at least one reference angle.

According to an embodiment, identifying the direction may include identifying at least one first touch position corresponding to the fourth event based on identifying the fourth event. Identifying the direction may include identifying the direction based on the at least one first touch position.

According to an embodiment, identifying the direction may include identifying at least one first touch range corresponding to the at least one first touch position. Identifying the direction may include identifying the direction by comparing the at least one first touch range with at least one first reference range.

According to an embodiment, identifying the direction may include identifying at least one second touch position corresponding to the fifth event based on identifying the fifth event. Identifying the direction may include identifying the direction based on the at least one second touch position.

According to an embodiment, identifying the direction may include identifying at least one second touch range corresponding to the at least one second touch position. Identifying the direction may include identifying the direction by comparing the at least one second touch range with at least one second reference range.

According to an embodiment, displaying the at least one icon may include identifying a sixth event related to connection of the at least one port 601; 602; 603; 604; 605; 606; 607; 608; 611; 612; 613. Displaying the at least one icon may include displaying the at least one icon based on the sixth event.

According to an embodiment, displaying the at least one icon may include updating at least one reference value corresponding to the at least one event based on the at least one event and the sixth event. Displaying the at least one icon may include displaying the at least one icon based on the updated at least one reference value.

According to an embodiment, updating the at least one reference value may include updating the at least one reference value corresponding to the at least one event based on the sixth event occurring within a reference time from a time when the at least one event occurs and a direction corresponding to the at least one event matching a direction corresponding to the sixth event.

According to an embodiment, displaying the at least one icon may include identifying one event among the at least one event based on a designated priority. Displaying the at least one icon may include displaying the at least one icon corresponding to the at least one port 601; 602; 603; 604; 605; 606; 607; 608; 611; 612; 613 based on the one event identified based on the designated priority.

According to an embodiment, the electronic device 101; 200 may include a communication module 190. The at least one operation may include obtaining information about the plurality of ports 601; 602; 603; 604; 605; 606; 607; 608; 611; 612; 613 from a server 108 through the communication module 190. The information may correspond to the plurality of ports 601; 602; 603; 604; 605; 606; 607; 608; 611; 612; 613.

According to an embodiment, an electronic device 101; 2400 may include a housing 2401; 2402, at least one port 601; 602; 603; 604; 605; 606; 607; 608; 611; 612; 613 disposed on a side surface of the housing 2401; 2402, a display 2430 disposed on a front surface of the housing 2401; 2402, and a processor 120. The processor 120 may be configured to identify at least one event of a first event corresponding to a shortcut key input, a second event corresponding to a gesture input, a third event corresponding to tilt detection, a fourth event corresponding to touch detection of the side surface of the housing 2401; 2402, or a fifth event corresponding to touch detection of a border of the display 2430. The processor 120 may be configured to display, based on the at least one event, at least one icon corresponding to at least one of the at least one port 601; 602; 603; 604; 605; 606; 607; 608; 611; 612; 613 on at least one area of the display 2430 corresponding to a position of the at least one port 601; 602; 603; 604; 605; 606; 607; 608; 611; 612; 613.

According to an embodiment, the electronic device 101; 2400 (e.g., the processor 120) may be configured to control the display 160; 2430 to display all of a plurality of icons corresponding to the plurality of ports 601; 602; 603; 604; 605; 606; 607; 608; 611; 612; 613 based on identifying at least one of a first event corresponding to a shortcut key input or a second event corresponding to a gesture input.

According to an embodiment, the electronic device 101; 2400 (e.g., the processor 120) may be configured to identify a direction corresponding to the at least one of the third event, the fourth event, or the fifth event based on identifying at least one of a third event corresponding to tilt detection, a fourth event corresponding to touch detection of the side surface of the housing 2401; 2402, or a fifth event corresponding to touch detection of a border of the display 160; 2430. The electronic device 101; 2400 (e.g., the processor 120) may be configured to control the display 160; 2430 to display at least one icon corresponding to at least one port 601; 602; 603; 604; 605; 606; 607; 608; 611; 612; 613 corresponding to the direction among the plurality of ports 601; 602; 603; 604; 605; 606; 607; 608; 611; 612; 613.

According to an embodiment, the electronic device 101; 2400 (e.g., the processor 120) may be configured to identify at least one tilt angle of the electronic device 101; 2400 corresponding to the third event based on identifying the third event. The electronic device 101; 2400 (e.g., the processor 120) may be configured to identify the direction by comparing the at least one tilt angle with at least one reference angle.

According to an embodiment, the electronic device 101; 2400 (e.g., the processor 120) may be configured to identify at least one first touch position corresponding to the fourth event based on identifying the fourth event. The electronic device 101; 2400 (e.g., the processor 120) may be configured to identify the direction based on the at least one first touch position.

According to an embodiment, the electronic device 101; 2400 (e.g., the processor 120) may be configured to identify at least one first touch range corresponding to the at least one first touch position. The electronic device 101; 2400 (e.g., the processor 120) may be configured to identify the direction by comparing the at least one first touch range with at least one first reference range.

According to an embodiment, the electronic device 101; 2400 (e.g., the processor 120) may be configured to identify at least one second touch position corresponding to the fifth event based on identifying the fifth event. The electronic device 101; 2400 (e.g., the processor 120) may be configured to identify the direction based on the at least one second touch position.

According to an embodiment, the electronic device 101; 2400 (e.g., the processor 120) may be configured to identify at least one second touch range corresponding to the at least one second touch position. The electronic device 101; 2400 (e.g., the processor 120) may be configured to identify the direction by comparing the at least one second touch range with at least one second reference range.

According to an embodiment, the electronic device 101; 2400 (e.g., the processor 120) may be configured to identify a sixth event related to connection of the at least one port 601; 602; 603; 604; 605; 606; 607; 608; 611; 612; 613. The electronic device 101; 2400 (e.g., the processor 120) may be configured to display the at least one icon based on the sixth event.

According to an embodiment, the electronic device 101; 2400 (e.g., the processor 120) may be configured to update at least one reference value corresponding to the at least one event based on the at least one event and the sixth event. The electronic device 101; 2400 (e.g., the processor 120) may be configured to display the at least one icon based on the updated at least one reference value.

According to an embodiment, the electronic device 101; 2400 (e.g., the processor 120) may be configured to update the at least one reference value corresponding to the at least one event based on the sixth event occurring within a reference time from a time when the at least one event occurs and a direction corresponding to the at least one event matching a direction corresponding to the sixth event.

According to an embodiment, the electronic device 101; 2400 (e.g., the processor 120) may be configured to identify one event among the at least one event based on a designated priority. The electronic device 101; 2400 (e.g., the processor 120) may be configured to display the at least one icon corresponding to the at least one port 601; 602; 603; 604; 605; 606; 607; 608; 611; 612; 613 based on the one event identified based on the designated priority.

According to an embodiment, the electronic device 101; 2400 may include a communication module 190. The electronic device 101; 2400 (e.g., the processor 120) may be configured to obtain information about the plurality of ports 601; 602; 603; 604; 605; 606; 607; 608; 611; 612; 613 from a server 108 through the communication module 190. The information may correspond to the plurality of ports 601; 602; 603; 604; 605; 606; 607; 608; 611; 612; 613.

According to an embodiment, a method of operating an electronic device 101; 2400 may include identifying at least one event of a first event corresponding to a shortcut key input, a second event corresponding to a gesture input, a third event corresponding to tilt detection, a fourth event corresponding to touch detection of a side surface of a housing 2401; 2402 of the electronic device 101; 2400, or a fifth event corresponding to touch detection of a border of a display 2430 of the electronic device 101; 2400. The method may include displaying, based on the at least one event, at least one icon corresponding to at least one of at least one port 601; 602; 603; 604; 605; 606; 607; 608; 611; 612; 613 of the electronic device 101; 2400 on at least one area of the display 2430 corresponding to a position of the at least one port 601; 602; 603; 604; 605; 606; 607; 608; 611; 612; 613.

According to an embodiment, displaying the at least one icon may include displaying all of a plurality of icons corresponding to the plurality of ports 601; 602; 603; 604; 605; 606; 607; 608; 611; 612; 613 based on identifying at least one of a first event corresponding to a shortcut key input or a second event corresponding to a gesture input.

According to an embodiment, displaying the at least one icon may include identifying a direction corresponding to the at least one of the third event, the fourth event, or the fifth event based on identifying at least one of a third event corresponding to tilt detection, a fourth event corresponding to touch detection of the side surface of the housing 2401; 2402, or a fifth event corresponding to touch detection of a border of the display 160; 2430. Displaying the at least one icon may include displaying at least one icon corresponding to at least one port 601; 602; 603; 604; 605; 606; 607; 608; 611; 612; 613 corresponding to the direction among the plurality of ports 601; 602; 603; 604; 605; 606; 607; 608; 611; 612; 613.

According to an embodiment, identifying the direction may include identifying at least one tilt angle of the electronic device 101; 2400 corresponding to the third event based on identifying the third event. Identifying the direction may include identifying the direction by comparing the at least one tilt angle with at least one reference angle.

According to an embodiment, identifying the direction may include identifying at least one first touch position corresponding to the fourth event based on identifying the fourth event. Identifying the direction may include identifying the direction based on the at least one first touch position.

According to an embodiment, identifying the direction may include identifying at least one first touch range corresponding to the at least one first touch position. Identifying the direction may include identifying the direction by comparing the at least one first touch range with at least one first reference range.

According to an embodiment, identifying the direction may include identifying at least one second touch position corresponding to the fifth event based on identifying the fifth event. Identifying the direction may include identifying the direction based on the at least one second touch position.

According to an embodiment, identifying the direction may include identifying at least one second touch range corresponding to the at least one second touch position. Identifying the direction may include identifying the direction by comparing the at least one second touch range with at least one second reference range.

According to an embodiment, displaying the at least one icon may include identifying a sixth event related to connection of the at least one port 601; 602; 603; 604; 605; 606; 607; 608; 611; 612; 613. Displaying the at least one icon may include displaying the at least one icon based on the sixth event.

According to an embodiment, displaying the at least one icon may include updating at least one reference value corresponding to the at least one event based on the at least one event and the sixth event. Displaying the at least one icon may include displaying the at least one icon based on the updated at least one reference value.

According to an embodiment, updating the at least one reference value may include updating the at least one reference value corresponding to the at least one event based on the sixth event occurring within a reference time from a time when the at least one event occurs and a direction corresponding to the at least one event matching a direction corresponding to the sixth event.

According to an embodiment, displaying the at least one icon may include identifying one event among the at least one event based on a designated priority. Displaying the at least one icon may include displaying the at least one icon corresponding to the at least one port 601; 602; 603; 604; 605; 606; 607; 608; 611; 612; 613 based on the one event identified based on the designated priority.

According to an embodiment, the electronic device 101; 2400 may include a communication module 190. The method may include obtaining information about the plurality of ports 601; 602; 603; 604; 605; 606; 607; 608; 611; 612; 613 from a server 108 through the communication module 190. The information may correspond to the plurality of ports 601; 602; 603; 604; 605; 606; 607; 608; 611; 612; 613.

According to an embodiment, in a computer readable recording medium storing instructions configured to perform at least one operation by a processor 120 of an electronic device 101; 2400, the at least one operation may include identifying at least one event of a first event corresponding to a shortcut key input, a second event corresponding to a gesture input, a third event corresponding to tilt detection, a fourth event corresponding to touch detection of a side surface of a housing 2401; 2402 of the electronic device 101; 2400, or a fifth event corresponding to touch detection of a border of a display 2430 of the electronic device 101; 2400. The at least one operation may include displaying, based on the at least one event, at least one icon corresponding to at least one of at least one port 601; 602; 603; 604; 605; 606; 607; 608; 611; 612; 613 of the electronic device 101; 2400 on at least one area of the display 2430 corresponding to a position of the at least one port 601; 602; 603; 604; 605; 606; 607; 608; 611; 612; 613.

According to an embodiment, displaying the at least one icon may include displaying all of a plurality of icons corresponding to the plurality of ports 601; 602; 603; 604; 605; 606; 607; 608; 611; 612; 613 based on identifying at least one of a first event corresponding to a shortcut key input or a second event corresponding to a gesture input.

According to an embodiment, displaying the at least one icon may include identifying a direction corresponding to the at least one of the third event, the fourth event, or the fifth event based on identifying at least one of a third event corresponding to tilt detection, a fourth event corresponding to touch detection of the side surface of the housing 2401; 2402, or a fifth event corresponding to touch detection of a border of the display 160; 2430. Displaying the at least one icon may include displaying at least one icon corresponding to at least one port 601; 602; 603; 604; 605; 606; 607; 608; 611; 612; 613 corresponding to the direction among the plurality of ports 601; 602; 603; 604; 605; 606; 607; 608; 611; 612; 613.

According to an embodiment, identifying the direction may include identifying at least one tilt angle of the electronic device 101; 2400 corresponding to the third event based on identifying the third event. Identifying the direction may include identifying the direction by comparing the at least one tilt angle with at least one reference angle.

According to an embodiment, identifying the direction may include identifying at least one first touch position corresponding to the fourth event based on identifying the fourth event. Identifying the direction may include identifying the direction based on the at least one first touch position.

According to an embodiment, identifying the direction may include identifying at least one first touch range corresponding to the at least one first touch position. Identifying the direction may include identifying the direction by comparing the at least one first touch range with at least one first reference range.

According to an embodiment, identifying the direction may include identifying at least one second touch position corresponding to the fifth event based on identifying the fifth event. Identifying the direction may include identifying the direction based on the at least one second touch position.

According to an embodiment, identifying the direction may include identifying at least one second touch range corresponding to the at least one second touch position. Identifying the direction may include identifying the direction by comparing the at least one second touch range with at least one second reference range.

According to an embodiment, displaying the at least one icon may include identifying a sixth event related to connection of the at least one port 601; 602; 603; 604; 605; 606; 607; 608; 611; 612; 613. Displaying the at least one icon may include displaying the at least one icon based on the sixth event.

According to an embodiment, displaying the at least one icon may include updating at least one reference value corresponding to the at least one event based on the at least one event and the sixth event. Displaying the at least one icon may include displaying the at least one icon based on the updated at least one reference value.

According to an embodiment, updating the at least one reference value may include updating the at least one reference value corresponding to the at least one event based on the sixth event occurring within a reference time from a time when the at least one event occurs and a direction corresponding to the at least one event matching a direction corresponding to the sixth event.

According to an embodiment, displaying the at least one icon may include identifying one event among the at least one event based on a designated priority. Displaying the at least one icon may include displaying the at least one icon corresponding to the at least one port 601; 602; 603; 604; 605; 606; 607; 608; 611; 612; 613 based on the one event identified based on the designated priority.

According to an embodiment, the electronic device 101; 2400 may include a communication module 190. The at least one operation may include obtaining information about the plurality of ports 601; 602; 603; 604; 605; 606; 607; 608; 611; 612; 613 from a server 108 through the communication module 190. The information may correspond to the plurality of ports 601; 602; 603; 604; 605; 606; 607; 608; 611; 612; 613.

Based on the above-described embodiments, the electronic device 101; 200; 2400 may enhance usability of the electronic device 101; 200; 2400 by guiding a user to positions of the ports 601; 602; 603; 604; 605; 606; 607; 608; 611; 612; 613 disposed on the electronic device 101; 200; 2400. Based on the above-described embodiments, the electronic device 101; 200; 2400 may reduce power consumption of the electronic device 101; 200; 2400 by guiding a user to a position of a port in a direction corresponding to at least one event among the ports 601; 602; 603; 604; 605; 606; 607; 608; 611; 612; 613 disposed on the electronic device 101; 200; 2400.

An embodiment of the disclosure and terms used therein are not intended to limit the technical features described in the disclosure to specific embodiments, and should be understood to include various modifications, equivalents, or substitutes of the embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. According to embodiments, each component of the above-described components may include a single entity or multiple entities. Some of the plurality of entities may be separately disposed in different components. According to embodiments, one or more of the above-described components may be omitted, or one or more other components may be added. Alternatively or additionally, a plurality of components may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by components may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing including a first surface and a second surface facing in a direction opposite to a direction in which the first surface faces;
a second housing including a third surface and a fourth surface facing in a direction opposite to a direction in which the third surface faces;
a hinge disposed between the first housing and the second housing, the hinge being configured to change a folding state of the electronic device;
a foldable display disposed on the first surface and the third surface;
a plurality of ports disposed on a side surface of the first housing or a side surface of the second housing;
memory, comprising one or more storage media, storing instructions; and
one or more processors communicatively coupled to the foldable display, and the memory,
wherein the instructions, when executed by the one or more processors individually or collectively, cause the electronic device to:
identify the folding state,
identify at least one event, and
display, based on the folding state and the at least one event, at least one icon corresponding to at least one port among the plurality of ports on at least one area of the foldable display, the at least one area corresponding to a position of the at least one port among the plurality of ports.

2. The electronic device of claim 1, wherein the instructions, when executed by the one or more processors individually or collectively, further cause the electronic device to control the foldable display to display all of a plurality of icons corresponding to the plurality of ports, based on identifying at least one of a first event corresponding to a shortcut key input, or a second event corresponding to a gesture input.

3. The electronic device of claim 2, wherein the instructions, when executed by the one or more processors individually or collectively, further cause the electronic device to:
identify a direction corresponding to at least one of a third event, a fourth event, or a fifth event, based on identifying the at least one of the third event corresponding to tilt detection, the fourth event corresponding to touch detection of the side surface of the first housing or the side surface of the second housing, or the fifth event corresponding to touch detection of a border of the foldable display; and
control the foldable display to display at least one icon corresponding to at least one port of the plurality of ports, the at least one port corresponding to the direction.

4. The electronic device of claim 3, wherein the instructions, when executed by the one or more processors individually or collectively, further cause the electronic device to:
identify, based on the folding state being a first state, a first direction as the direction, the first direction corresponding to the at least one event; and
identify, based on the folding state being a second state, a second direction as the direction, the second direction corresponding to the at least one event and the second state.

5. The electronic device of claim 4, wherein the instructions, when executed by the one or more processors individually or collectively, further cause the electronic device to:
identify at least one tilt angle of the electronic device corresponding to the third event, based on identifying the third event; and
identify the direction by comparing the at least one tilt angle with at least one reference angle.

6. The electronic device of claim 5, wherein the instructions, when executed by the one or more processors individually or collectively, further cause the electronic device to:
identify at least one first touch position corresponding to the fourth event, based on identifying the fourth event; and
identify the direction based on the at least one first touch position.

7. The electronic device of claim 6, wherein the instructions, when executed by the one or more processors individually or collectively, further cause the electronic device to:
identify at least one first touch range corresponding to the at least one first touch position; and
identify the direction by comparing the at least one first touch range with at least one first reference range.

8. The electronic device of claim 7, wherein the instructions, when executed by the one or more processors individually or collectively, further cause the electronic device to:
identify at least one second touch position corresponding to the fifth event, based on identifying the fifth event; and
identify the direction based on the at least one second touch position.

9. The electronic device of claim 8, wherein the instructions, when executed by the one or more processors individually or collectively, further cause the electronic device to:
identify at least one second touch range corresponding to the at least one second touch position; and
identify the direction by comparing the at least one second touch range with at least one second reference range.

10. The electronic device of claim 9, wherein the instructions, when executed by the one or more processors individually or collectively, further cause the electronic device to:
identify a sixth event associated with a connection of the at least one port; and
display the at least one icon based on the sixth event.

11. The electronic device of claim 10, wherein the instructions, when executed by the one or more processors individually or collectively, further cause the electronic device to:
update at least one reference value corresponding to the at least one event based on the at least one event and the sixth event; and
display the at least one icon based on the updated at least one reference value.

12. The electronic device of claim 11, wherein the instructions, when executed by the one or more processors individually or collectively, further cause the electronic device to update the at least one reference value corresponding to the at least one event, based on the sixth event occurring within a reference time from a time at which the at least one event occurs and a direction corresponding to the at least one event matching a direction corresponding to the sixth event.

13. The electronic device of claim 12, wherein the instructions, when executed by the one or more processors individually or collectively, further cause the electronic device to:
identify one event of the at least one event based on a specified priority; and
display the at least one icon corresponding to the at least one port, based on the one event identified based on the specified priority.

14. The electronic device of claim 13, further comprising:
communication circuitry,
wherein the instructions, when executed by the one or more processors individually or collectively, further cause the electronic device to obtain, from a server via the communication circuitry, information about the plurality of ports, the information corresponding to the plurality of ports.

15. A method performed by an electronic device, the method comprising:
identifying, by the electronic device, a folding state of the electronic device;
identifying, by the electronic device, at least one event; and
displaying, by the electronic device based on the folding state and the at least one event, at least one icon corresponding to at least one port among a plurality of ports disposed on a side surface of a housing of the electronic device on at least one area of a foldable display of the electronic device,
wherein the at least one area corresponds to a position of the at least one port among the plurality of ports.

16. The method of claim 15, further comprising:
displaying all of a plurality of icons corresponding to the plurality of ports, based on identifying at least one of a first event corresponding to a shortcut key input, or a second event corresponding to a gesture input.

17. The method of claim 16, further comprising:
identifying a direction corresponding to at least one of a third event, a fourth event, or a fifth event, based on identifying the at least one of the third event corresponding to tilt detection, the fourth event corresponding to touch detection of the side surface of a first housing or the side surface of a second housing, or the fifth event corresponding to touch detection of a border of the foldable display; and
displaying at least one icon corresponding to at least one port of the plurality of ports, the at least one port corresponding to the direction.

18. The method of claim 17, further comprising:
identifying, based on the folding state being a first state, a first direction as the direction, the first direction corresponding to the at least one event; and
identifying, based on the folding state being a second state, a second direction as the direction, the second direction corresponding to the at least one event and the second state.

19. One or more non-transitory computer-readable storage media storing one or more computer programs including computer-executable instructions that, when executed by one or more processors of an electronic device individually or collectively, cause the electronic device to perform operations, the operations comprising:
identifying, by the electronic device, a folding state of the electronic device;
identifying, by the electronic device, at least one event; and
displaying, by the electronic device based on the folding state and the at least one event, at least one icon corresponding to at least one port among a plurality of ports disposed on a side surface of a housing of the electronic device on at least one area of a foldable display of the electronic device,
wherein the at least one area corresponds to a position of the at least one port among the plurality of ports.

20. The one or more non-transitory computer-readable storage media of claim 19, the operations further comprising:
displaying all of a plurality of icons corresponding to the plurality of ports, based on identifying at least one of a first event corresponding to a shortcut key input, or a second event corresponding to a gesture input.
